(19) United States
(12) Patent Application Publication
(10) Pub. No.: US 2021/0296900 A1
(43) Pub. Date: Sep. 23, 2021

(54) DATACENTER POWER MANAGEMENT THROUGH PHASE BALANCING

(71) Applicant: Virtual Power Systems, Inc., Milpitas, CA (US)

(72) Inventors: Ohannes Wanes, Richmond Hill (CA); Ricky Yim Yuen Chau, Toronto (CA); Roland Larocque, Whitby (CA); Paul Ruggier, Concord (CA)

(73) Assignee: Virtual Power Systems, Inc., Milpitas, CA (US)

(21) Appl. No.: 17/326,392

(22) Filed: May 21, 2021

Related U.S. Application Data
(63) Continuation-in-part of application No. 17/206,186, filed on Mar. 19, 2021.
(60) Provisional application No. 63/147,254, filed on Feb. 9, 2021.
(60) Provisional application No. 63/119,003, filed on Nov. 30, 2020.
(60) Provisional application No. 63/084,597, filed on Sep. 29, 2020.
(60) Provisional application No. 63/052,476, filed on Jul. 16, 2020.
(60) Provisional application No. 63/039,000, filed on Jun. 15, 2020.
(60) Provisional application No. 62/992,186, filed on Mar. 20, 2020.

(51) Int. Cl. H02J 3/28; H02J 3/14; G06F 9/50; G06F 1/26

(52) U.S. Cl. CPC H02J 3/28; H02J 3/14; G06F 9/505; G06F 1/26; G06F 9/5094

(57) ABSTRACT

Disclosed techniques for power management include datacenter power management through phase balancing. Power for a datacenter is obtained across a plurality of AC power phases. A power consumption value by loads is determined within the datacenter for each of a plurality of power phases. A power consumption imbalance is calculated between a first phase and a second phase from the plurality of power phases within the datacenter. Phase power balancing is performed by transferring power from the first phase to the second phase from the plurality of power phases within the datacenter. The transferring power is accomplished using current injection. The performing phase power balancing by transferring power from the first phase to the second phase comprises a supply side transfer of power. Performing phase power balancing by transferring power from the first phase to the second phase is accomplished without transferring load power consumption between power phases.

### RELATED APPLICATIONS

This application claims the benefit of U.S. provisional patent applications “Datacenter Power Management Through Phase Balancing” Ser. No. 63/039,000, filed Jun. 15, 2020, “Datacenter Current Injection For Power Management” Ser. No. 63/052,476, filed Jul. 16, 2020, “Datacenter Power Management With Edge Block Mediation” Ser. No. 63/084,597, filed Sep. 29, 2020, “Datacenter Power Management Using Adaptive Interfacing” Ser. No. 63/119,003, filed Nov. 30, 2020, and “Datacenter Power Management With Distributed Policy Interaction” Ser. No. 63/147,254, filed Feb. 9, 2021.

This application is also a continuation-in-part of U.S. patent application “Datacenter Power Management Using Current Injection” Ser. No. 17/206,186, filed Mar. 19, 2021, which claims the benefit of U.S. provisional patent applications “Datacenter Power Management Using Current Injection” Ser. No. 62/992,186, filed Mar. 20, 2020, “Datacenter Current Injection For Power Management” Ser. No. 63/052,476, filed Jul. 16, 2020, “Datacenter Power Management Through Phase Balancing” Ser. No. 63/039,000, filed Jun. 15, 2020, “Datacenter Power Management With Edge Block Mediation” Ser. No. 63/084,597, filed Sep. 29, 2020, “Datacenter Power Management Using Adaptive Interfacing” Ser. No. 63/119,003, filed Nov. 30, 2020, and “Datacenter Power Management With Distributed Policy Interaction” Ser. No. 63/147,254, filed Feb. 9, 2021.

Each of the foregoing applications is hereby incorporated by reference in its entirety.

### FIELD OF ART

This application relates generally to power management and more particularly to datacenter power management through phase balancing.

### BACKGROUND

The information technology (IT) operations of a wide range of organizations are supported to handle data. The computing and other electrical equipment that is required to support these IT operations is housed in facilities called datacenters, which are sometimes called “server farms”. The organizations include online retailers, financial institutions, search providers, research laboratories, universities, hospitals, and other computing-intensive organizations that conduct operations using their datacenters. The datacenters support a wide range of data processing and other applications, data storage and data access, and networking infrastructure, among many other processing requirements. A typical datacenter houses a vast network of heterogeneous, critical systems, the continuous operation of which is indispensable to the success of the organization. The critical systems can include servers, storage devices, routers, and other IT equipment. The critical systems are often housed in rows of equipment racks, which are also referred to data racks or information technology racks. The proprietary, confidential, and personal information stored on and processed by these critical systems must be protected from corruption, loss, or theft. As a result, the security and reliability of datacenters and the information within them is a high priority of the organizations. Further, the wide range of processing requirements and the quantity of the processing equipment cause datacenters to consume prodigious amounts of electrical power. In fact, the amount of power consumed by a typical datacenter often accounts for a substantial portion of an organization's operating budget, merely to cover the cost of electricity.

Some businesses choose to build and maintain their own datacenters in-house, while others rent servers at co-location facilities, or use cloud-based services. The computing systems found within datacenters are constructed from a vast number of electrical and electronic components, which include printed circuit boards populated with integrated circuits or “chips”, mass storage devices based on magnetic optical, or electronic storage technologies, networking interfaces, and processors. The processors include central processing units (CPUs), graphics processing units (GPUs), storage or memory management units (MMUs), among many others. Given the precise and ever-increasing power requirements demanded by these components, reliable and efficient power delivery is crucial to operation of the datacenters. Further, the power requirements can change dramatically depending on the processing requirements occurring at a given time. For many organizations, the computer systems must meet or exceed statutory requirements for reliability and availability. Financial institutions and healthcare organizations are required by law to meet certain standards for the protection of data maintained and processed by the organizations. Additionally, educational organizations and retail businesses face other statutory requirements which mandate that certain standards must be met to protect personal, educational, and consumer data. The statutory requirements dictate stringent safeguards on the physical and technical security of personal data by requiring physical security of the systems and encryption of the data. Regardless of the computer system and infrastructure requirements of a given type of institution, key infrastructure specifications must be met in order to address the important issues of availability, reliability, job load, and other organizational requirements of datacenters.

### SUMMARY

The management of power loads within datacenters includes construction and design of the datacenters for redundancy, power distribution, and cooling. Effective management of the many and varied power loads within a datacenter is a very significant and complex challenge. The computational, storage, network, and other electrical equipment within a datacenter require large amounts of power to function properly. In addition, the datacenter power requirements are dynamic because the quantity of computational and other equipment required to execute the processing tasks and other tasks vary over time. Power requirements are further dependent on contractual obligations to provide a level of computing capability; reliability requirements such as redundant power grids for high-availability datacenters; statutory requirements for physical and electronic security, redundancy, and availability; and so on. Nearly all datacenters use three-phase power that is obtained through regional and/or commercial electrical grids. Other power sources that are used include locally generated power or “micro grids”, which provide power from hydro, wind, solar, wave action, and other sources. The various loads within the datacenter are connected to one or more phases of the three-phase power. The loads can be distributed across the three phases, but since the power loads are dynamic, the loads coupled to the three phases can result in load imbalances. Conceptually, while it is easy to generate equal amounts of power for the three phases, the power drawn by loads coupled to the phases can be wildly unequal and time-variant, causing the three phases to become unbalanced. The more unbalanced the three phases become, the more problems are created. Power drops can occur, and phases and wires can become overheated. Other available current goes unused. To balance the three phases, the loads of the equipment power supplies might be spread across the three phases using infrastructure management tools that monitor loads and re-balance them. In datacenters, attaining a perfect load distribution over three phases is difficult to achieve and maintain because power is allocated and distributed to different clients, and the clients' processing requirements change.

Datacenter equipment power requirements often include AC loads and DC loads, where the loads depend on the type of equipment to which the power is being provided. The power requirements of the datacenter can vary extensively over time, based on application or job mix activity, planned maintenance, unplanned equipment failure, and other factors. The time-variable power requirements can include load increases during normal business hours and subsequent load decreases after business hours and/or on weekends and holidays, changes in cooling requirements based on season, unplanned load changes due to major events, and so on. The balance of AC load demand versus DC load demand can also change. Characterizing the behavior of datacenter power consumption and designing power management to handle dynamic power loads are essential to maintaining consistent operation and reliability of the datacenters. Use of local power sources, redundant power supplies, power caches, and similar techniques can be used to handle dynamic power needs. Power caches based on batteries or capacitors, for example, can be used to store power when excess power is available, then can provide power when power demands exceed available power. Power caches can be used more broadly within the datacenter to help enable 1N redundancy or 2N redundancy, to support carbon footprint management, to control the cost of energy, or to help select the source of energy.

Disclosed techniques address a computer-implemented method for power management. The power management enables datacenter power management through phase balancing. Power for a datacenter is obtained across a plurality of AC power phases. A power consumption value by loads is determined within the datacenter for each of the plurality of power phases. The plurality of power phases comprises three phases. A power consumption imbalance is calculated between a first phase and a second phase from the plurality of power phases within the datacenter. Phase power balancing is performed by transferring power from the first phase to the second phase from the plurality of power phases within the datacenter, wherein the transferring power is accomplished using current injection. Transferring power from a first phase to a second phase to a third phase is accomplished using daisy chain transfer. The power is transferred automatically. The performing phase power balancing by transferring power from the first phase to the second phase comprises a supply side transfer of power. Further, performing phase power balancing by transferring power from the first phase to the second phase is accomplished without transferring load power consumption between power phases. The transferring power can include transferring power from the second phase to a third phase of the plurality of power phases. The transferring from the first phase to the second phase to the third phase of the plurality of power phases is accomplished using daisy chained transfer. The transferring from the first phase to the second phase of the plurality of power phases is accomplished using unidirectional AC-to-AC direct transfer. The transferring from the first phase to the second phase of the plurality of power phases is accomplished using bidirectional AC-to-AC direct transfer.

A computer-implemented method for power management is disclosed comprising: obtaining power for a datacenter across a plurality of AC power phases; determining a power consumption value by loads within the datacenter for each of the plurality of power phases; calculating a power consumption imbalance between a first phase and a second phase from the plurality of power phases within the datacenter; and performing phase power balancing by transferring power from the first phase to the second phase from the plurality of power phases within the datacenter, wherein the transferring power is accomplished using current injection.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for datacenter power management through phase balancing.

FIG. 2 is a block diagram for intelligent control of energy.

FIG. 3 shows a 2N phase balancing network.

FIG. 4A is a block diagram of a power conversion module.

FIG. 4B is a block diagram for power conversion module usage.

FIG. 5A shows daisy chained transfer for a Delta configuration.

FIG. 5B shows daisy chained transfer for a Wye configuration.

FIG. 6 illustrates unidirectional direct transfer.

FIG. 7A shows direct transfer for a Delta configuration using N−1 PCMs with input and output switches.

FIG. 7B shows direct transfer for a Wye configuration using N−1 PCMs with input and output switches.

FIG. 8 illustrates bidirectional direct transfer.

FIG. 9 shows phase power balancing using a PCM.

FIG. 10 illustrates PCM phase power balancing connections.

FIG. 11A illustrates a block diagram for phase balancing without storage in a Wye configuration.

FIG. 11B illustrates a block diagram for phase balancing without storage in a Delta configuration.

FIG. 12 illustrates a datacenter rack configuration.

FIG. 13 illustrates pulse width modulation (PWM) of a sinusoid.

FIG. 14A is a block diagram for a charger.

FIG. 14B is a block diagram for a single-phase inverter.

FIG. 15 is a system diagram for datacenter power management through phase balancing.

### DETAILED DESCRIPTION

This disclosure provides techniques for datacenter power management through phase balancing. Managing the many information technology (IT) tasks, including the efficiency and reliability of power distribution, space allocation, and cooling capacity, is a highly complex, stringent, and challenging task. Datacenters pose particularly difficult resource management challenges because the supply of and demand for power must be carefully balanced. Some datacenters are designed for and dedicated to a single organization, while other datacenters provide contracted resources for utilization by multiple organizations. Datacenter usage by various organizations can be managed based on careful consideration of multiple factors. The factors can include the amount of equipment a given organization requires to locate in the datacenter; power load requirements; power source redundancy requirements such as 1N, 1N+1, or 2N redundancy; service level agreements (SLAs) and other contractual obligations for the power; etc. Datacenter power systems are designed to meet the dynamic power needs of large installations of diverse electrical equipment. A varied installation of processing and other electrical equipment can be installed in a datacenter, including devices such as servers, blade servers, communications switches, backup data storage units, communications hardware, and other devices. The electrical equipment can include one or more of processors; data servers; server racks; and heating, ventilating, and air conditioning (HVAC) units. The HVAC units are installed to manage humidity and the copious heat that is dissipated by all of the electrical equipment in the datacenter.

The power systems within the data center receive power from multiple power feeds, where the coupled power feeds can derive from grid power such as hydro, wind, solar, nuclear, coal, or other power plants; local power generated from micro-hydro, wind, solar, geothermal, etc.; diesel-generator (DG) sets; and so on. The multiple power feeds, typically numbering at least two feeds, provide critical and at times contracted redundancy for power delivery to the datacenter power system. That is, if one power feed were to fail or be taken offline for maintenance, then another power feed can provide without interruption the dynamic power needed to drive the power load of the datacenters. The power feeds can include three-phase power. In modern datacenters, the infrastructure within a datacenter can be controlled by software. The use of software-defined IT infrastructures, such as compute, network, or storage infrastructures, supports flexible and automated management of datacenter power. Many different datacenter structures and business models can be enhanced by the techniques disclosed within, including enterprise datacenters, co-location datacenters, hyperscale datacenters, brownfield datacenters, greenfield datacenters, microgrid datacenters, modularized datacenters, cloud processing datacenters, and so on.

The requirements for power within modern datacenter operations are exacting. The dynamic datacenter power requirements can change quickly and widely over time due to the quantity, type, and mix of datacenter equipment; changes in positioning of datacenter racks; changes in cooling requirements; and other electrical, thermal, and deployment factors. Power requirements are further based on the mix or combination of the processing jobs executing at a given time. Power requirements are dependent on the loads that are being driven, where the loads include AC and DC loads. For example, power requirements can increase during normal business hours, and decrease after-hours and/or on weekends or holidays. Furthermore, the makeup of AC load demand vs. DC load demand can change as equipment in the datacenter is added or swapped out. Factors that are less predictable, or “soft” factors, include the scheduling of various batch jobs such as processing payroll and other processing tasks. The power requirement fluctuations can be influenced by required software or application activity, planned maintenance, unplanned events such as equipment failure, etc.

Disclosed techniques enable datacenter power management through phase balancing. Power is typically fed to a datacenter using three-phase or polyphase power, where power at a given voltage and a frequency is provided using multiple conductors. The voltage provided on the multiple conductors is determined relative to a common reference, where the reference can be common, neutral, and so on. Three-phase power, for example, is preferred relative to single-phase power because three times as much power can be provided using three conductors relative to two conductors (power and neutral) used for single-phase power. The three-phase power is distributed throughout the datacenter to power loads within the datacenter.

Each phase within polyphase power is configured to provide an amount of power at the same voltage and frequency. One or more of the power phases are provided to the various power loads within the datacenter, depending on power needs, redundancy requirements, etc. As electrical equipment such as processors, communications gear, HVAC components, UPSs, etc., is added the mix of hardware or exchanged with existing pieces of hardware within the datacenter, power consumption from each power phase can increase. In addition, the power load requirements of a given phase can vary based on how the equipment is operated (low power, nominal, accelerated), the processing jobs assigned to the equipment, and so on. As a result, power consumption imbalances can exist between or among the power phases. Traditionally, equipment could be disconnected from one phase and connected to another. However, this practice is no longer viable. While the equipment loads can be distributed among the phases based on one target operating point or job mix, simply changing the job mix assigned to processors or boosting clock rate of the processors can invalidate the distribution of the loads among the phases. Instead, phase balancing can be performed. Phase balancing can transfer power from one phase that is underutilized to a phase that is overutilized.

In disclosed techniques, power management within a datacenter is accomplished through phase balancing. Power from an underutilized phase can be transferred to an overutilized phase. The transferring of power accomplishes datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter. The phase power balancing is accomplished using a power conversion module (PCM).

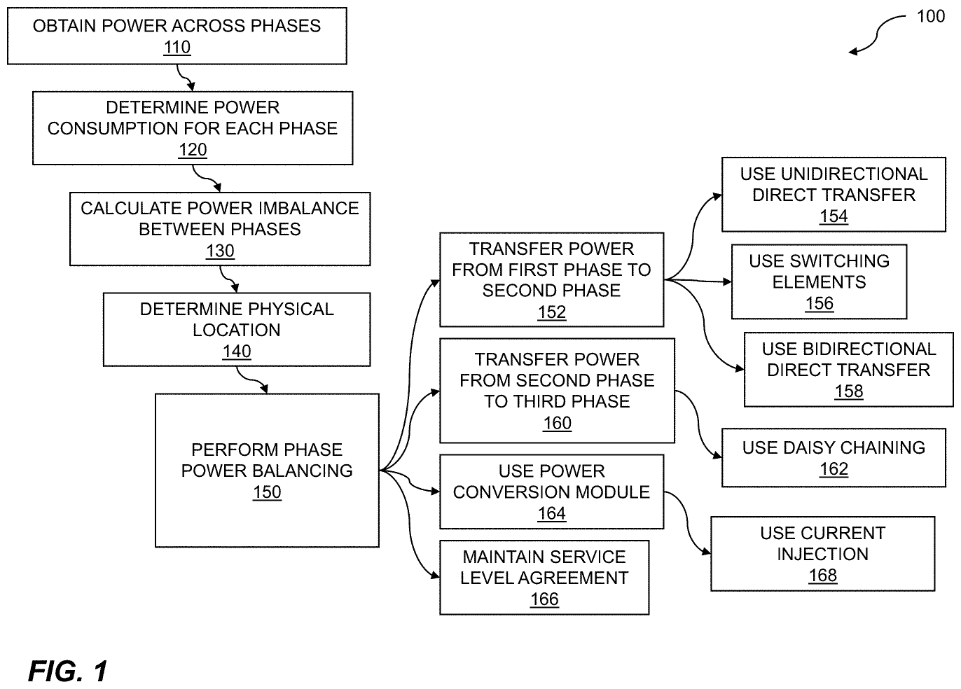

FIG. 1 is a flow diagram for datacenter power management through phase balancing. The amount and type of power provided to IT equipment within a datacenter can be determined based on contractual or service level agreements, power sources available, backup power sources available, job mixes, job scheduling, and so on. The flow 100 shows a computer-implemented method for power management. The flow 100 includes obtaining power for a datacenter across a plurality of power phases 110. In embodiments, the plurality of power phases can include three phases, although two or more phases can be included. The power phases can be obtained from grid or utility power, where the grid power can include generation sources such as hydro, coal, nuclear, natural gas, and so on. The power phases also can be obtained from renewable energy sources such as large-scale solar or wind, geothermal, tidal, wave action, etc. The plurality of power phases can include equal voltage and frequency AC power, where the phase of the AC power is shifted between one phase and another phase. The power can be obtained from on-site power sources such as wind, solar, micro-hydro, diesel-generator sets (DG), etc.

The flow 100 includes determining a power consumption value 120 by loads within the datacenter for each of the plurality of power phases. Several factors can contribute to the power consumption value determined for a phase. The power consumption value can include power loads based on processing, communications, backup, uninterruptable power supply (UPS), HVAC, and other electrical equipment coupled to the phase. The power consumption value can also include power loads based on an operating point for processors, where the processors can be in low power or standby mode, nominal operating mode, accelerated mode for which processor clock rates are boosted, etc. The power consumption value can be based on the mix of jobs executing on processors, where the mix of jobs can be based on job priorities, contractual agreements, known days of a month when heavy processing loads can be expected such as running payroll, etc. The flow 100 includes calculating a power consumption imbalance 130 between a first phase and a second phase from the plurality of power phases within the datacenter. The power consumption values that can be determined for each phase can be compared to determine whether there is a power consumption imbalance for a phase relative to one or more other phases. In embodiments and discussed below, a phase consumption imbalance can be compared to a value such as a threshold value. The phase consumption imbalance can be ranked, where the ranks can include low concern, concern or watch, high concern, and so on. The rank can contribute to power consumption imbalance remediation. The flow 100 includes determining a physical location 140 for the power consumption imbalance. The physical location can be determined based on various granularities such as a region within a datacenter, a row, a rack within a row, a processor within a rack, and so on.

The flow 100 can include performing phase power balancing 150. Performing phase power balancing can include equalizing an amount of power provided to static power loads and dynamic power loads coupled to the power phases. In embodiments, the phase power balancing can be performed based upon a threshold value of power imbalance. The threshold can be based on a maximum power load, on a minimum power available for transfer, and so on. In embodiments, the phase power balancing can be performed to avoid tripping a circuit breaker on one of the phases from the plurality of power phases. Tripping a circuit breaker can be avoided by keeping power demand below an acceptable maximum value. In other embodiments, the phase power balancing can be performed to avoid a limit due to wiring or transformer capacities on one of the phases from the plurality of power phases. Current rating of wire can be based on an amount of current and a length of wire. Keeping power loads below a threshold value can reduce fire risk and can help protect the wire. Similarly, a current threshold can be maintained for a transformer. In further embodiments, the phase power balancing can be performed based on a power policy. The power policy can include providing an amount of power to run equipment. Additional current can be provided if the policy permits it, or the current can be provided elsewhere to meet other policies, to protect equipment, to meet higher priority policy, and the like.

The flow 100 includes transferring power from the first phase to the second phase 152 from the plurality of power phases within the datacenter. In embodiments, the performing phase power balancing by transferring power from the first phase to the second phase is accomplished automatically. The transferring of power from a first phase to a second phase can include identifying a phase with excess power capacity and providing some or all of that excess capacity to a phase identified as having insufficient power capacity. In embodiments, the performing phase power balancing by transferring power from the first phase to the second phase can be accomplished by supply side transfer of power. Supply side transfer of power implies adjusting an amount of power provided by a given phase rather than moving loads from one power phase to another power phase. Recall that simply moving loads from one phase to another phase does not necessarily accomplish power balancing since the loads drawn by various pieces of electrical equipment can vary dynamically. In embodiments, performing phase power balancing by transferring power from the first phase to the second phase is accomplished without transferring load power consumption between or among power phases.

In the flow 100, the transferring from the first phase to the second phase of the plurality of power phases can be accomplished using unidirectional 154 AC-to-AC direct transfer. Unidirectional transfer can include transferring power from a first phase to a second phase. If power is to be transferred from the second phase back to the first phase, then the power from the second phase is transferred from the second phase to a third phase, then from the third phase back to the first phase. In the flow 100, the transferring is accomplished using switching elements 156. The switching elements can include electrically operated switches, smart switches, and the like. In the flow 100, the transferring from the first phase to the second phase of the plurality of power phases is accomplished using bidirectional 158 AC-to-AC direct transfer. Bidirectional direct transfer can include transferring power from the first phase to the second phase or from the second phase back to the first phase; from the second phase to the third phase or from the third phase to the second phase; etc. Power can be transferred to other phases. The flow 100 further includes transferring power from the second phase to a third phase 160 of the plurality of power phases. While three phases are discussed, the transferring of power from phase to phase can be performed for additional phases within a polyphase power system. The transferring of power from phase to phase can be accomplished using a variety of techniques. In embodiments, the transferring from the first phase to the second phase to the third phase of the plurality of power phases can be accomplished using daisy chained 162 transfer. A daisy chain transfer includes transferring power from one phase to another phase until the phase to which the power is being transferred is reached.

In the flow 100, the phase power balancing is accomplished using a power conversion module 164 (PCM). A power conversion module can be used to convert one voltage to another voltage, to convert AC power to DC power, to convert DC power to AC power or DC power at a different voltage, and so on. The PCM can be used to provide AC power from a battery backup system such as an uninterruptable power supply (UPS). In embodiments, the phase power balancing is accomplished without a battery being included in the power conversion module. Instead, the PCM might use a power cache, battery backup, and so on. In other embodiments, the power conversion module can be coupled to a supplemental battery pack. The supplemental battery pack can be used in addition to any other DC power sources such as power caches, batteries, capacitors, etc. In further embodiments, the power conversion module enables a charger and an inverter simultaneously. The PCM charger can be used to charge batteries, capacitors, supplemental batteries, etc., while the PCM inverter can be used to convert the DC power stored within the batteries or supplemental, capacitors, etc., to AC power. In other embodiments, the transferring power from the first phase to the second phase is accomplished in proximity to the physical location for the power consumption imbalance. The transferring power from the first phase to the second phase can be accomplished within a processor, within a rack, within a row, within a region of the datacenter, and so on. The power conversion module can use current injection 168 to enable phase balancing. The current injection can be controlled using pulse width modulation. The pulse width modulation can be enabled by one or more current mode grid tie inverters. The current injection does not disturb the voltage present on the second phase. The current injection does not disturb the phase of AC frequency present on the second phase.

In the flow 100, the phase power balancing is accomplished while maintaining a service level agreement 166 redundancy level. A service level agreement (SLA) can be established between an owner or operator of a data center and a client of the datacenter. The SLA can include an amount of rack space or number of racks within the datacenter; an amount of processing time, a level of availability such as high availability, a level of redundancy, and so on. In embodiments, the redundancy level can include 2N redundancy. 2N redundancy can provide two sources of power, which each source of power can include polyphase power. In other embodiments, the redundancy level can include N redundancy. N redundancy can provide a single source of polyphase power two one or more pieces of equipment within a datacenter. In further embodiments, the redundancy level can include N+1 redundancy. N+1 redundancy can provide a single power source to pieces of equipment and can provide one “spare”. The spare can be coupled to a piece of equipment if the original power source fails, goes offline, or otherwise becomes unavailable.

Various embodiments of the flow 100 can be included in a computer program product embodied in a non-transitory computer readable medium that includes code executable by one or more processors.

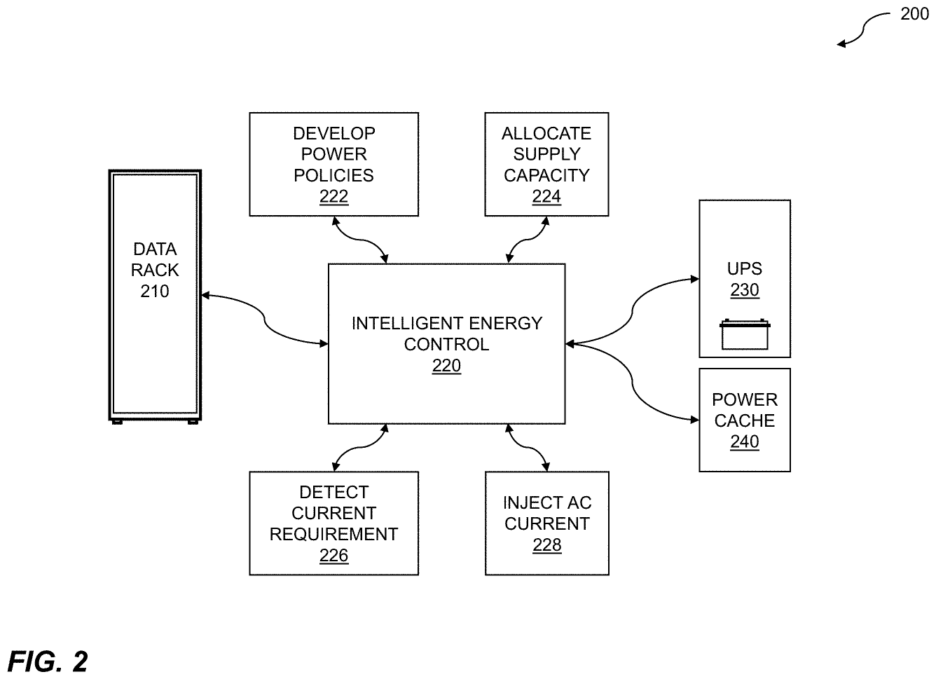

FIG. 2 is a block diagram for intelligent control of energy 200. Power management of energy within a datacenter can be based on intelligent control. Intelligent control of energy, including AC energy and DC energy, enables datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

Intelligent energy control can include a datacenter power policy. The datacenter power policy, which can be based on processing and electrical equipment within a datacenter, usage requirements, contractual obligations, and so on, can be used to control power consumption by processors or electrical equipment, to prioritize allocation of power to equipment, to schedule processing tasks, etc. Intelligent energy control can include communication with equipment within the datacenter in order to manage that equipment. The communication can include connecting to the various items of electrical equipment; collecting status, state, and other data from the electrical equipment; and controlling the electrical equipment. The electrical equipment can include processors, servers, and communication equipment; backup and storage; power distribution equipment; cooling equipment; etc. The type of equipment and the capabilities of the equipment to be controlled can determine the level of intelligent energy control of the equipment. Some equipment within the datacenter can be controlled by policies that can be loaded onto the equipment. This equipment can support intelligent control. Equipment that can be controlled locally using intelligent control can comprise compatible components, where the compatible components can include compatible power distribution units (PDUs), compatible uninterruptable power supplies (UPSs), compatible electrical distribution switch gear, etc. Other equipment or components within the datacenter cannot be controlled locally using intelligent control, but can be controlled centrally by intelligent energy control. This latter type of equipment can support direct control. These other components can include other PDUs, other UPSs, other switch gears, and so on. Further equipment within the datacenter can be controlled by intelligent energy control. This further equipment can comprise infrastructure management, where infrastructure management can include HVAC management, facilities management, IT server management, and so on.

A data rack 210 can contain processors, servers, communication equipment, and so on, where the equipment within the data rack can be operated, adjusted, manipulated, and so on by intelligent energy control 220. Intelligent energy control can include turning on and off electrical equipment such as servers, blade servers, data servers, communications equipment, etc.; shifting virtual machines to slower processers to reduce power consumption; slowing processor clock rates of servers or blade servers to reduce power consumption; and the like. The intelligent energy control can be based on developing one or more power policies 222. A power policy can be used to oversee a datacenter topology. The datacenter topology comprises energy sources such as utility grid power, power caches, power control blocks, UPSs, loads, etc. The intelligent energy control can include allocating a supply capacity 224. The supply capacity can be allocated from a power source, where the power source can include a UPS 230. In embodiments, the supply capacity can be allocated from a power cache 240, where the power cache can include one or more batteries, capacitors, etc. The supply capacity can be allocated below a peak load requirement, below a threshold value, etc. Intelligent energy control can include detecting an AC current requirement 226 for one or more loads. The loads can be at the output network of a UPS. The detecting can be performed by one or more power control blocks. Intelligent energy control can include injecting AC current 228 into a network, where the network can include the output network of the UPS. The injecting can be performed by the power control blocks.

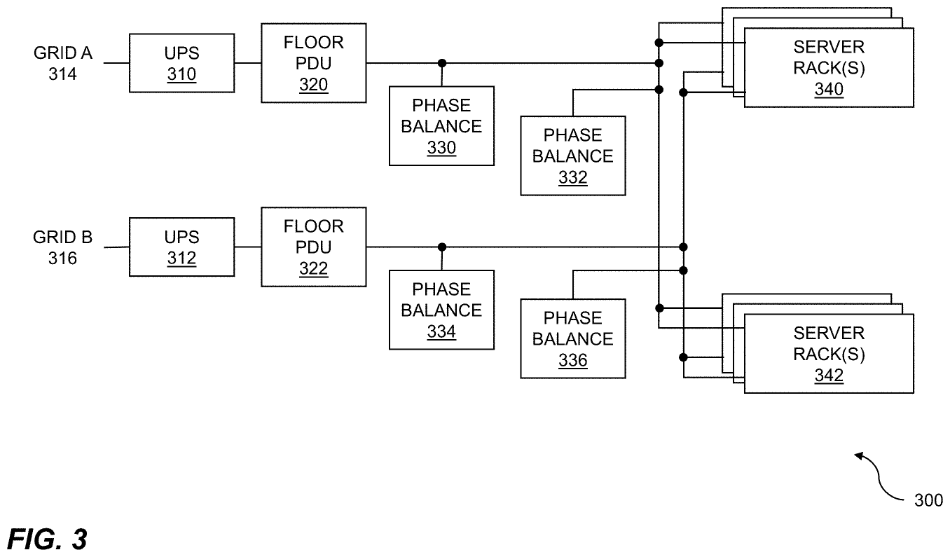

FIG. 3 shows a 2N phase balancing network. Redundancy, such as 2N redundancy, provides two power sources for each piece of equipment within a datacenter. The 2N redundancy enables one or more pieces of equipment to continue to operate even in the event that one phase goes down due to failure, scheduled maintenance, and so on. A 2N phase balancing network enables datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

A 2N phase balancing network is shown 300. The network includes a first UPS 310 and a second UPS 312. Each UPS includes a charger to charge one or more batteries, an inverter to convert DC energy stored in the one or more batteries to an AC voltage, and a bypass switch. Each UPS receives power such as grid power A 314 coupled to UPS 310, and grid power B 316 coupled to UPS 312. Each UPS is coupled to a floor level power distribution unit (PDU). In the figure, UPS 310 is coupled to PDU 320, and UPS 312 is coupled to PDU 322. The UPSs can provide multiple power phases, such as three phases. The PDUs are coupled to phase balancing components. The phase balancing components can perform power balancing by transferring from one phase to another phase. In the diagram, the PDU 320 is coupled to two phase balancing components 330 and 332. The phase balancing components 330 and 332 can provide balanced power to plurality of server racks such as server racks 340 and 342. The phase balancing can include phase balancing among the plurality of servers within each server rack, and among the plurality of server racks. Similarly, the PDU 322 is coupled to two phase balancing components 334 and 336. The phase balancing components 334 and 336 provide phase balancing to the plurality of server racks 340 and the plurality of server racks 342.

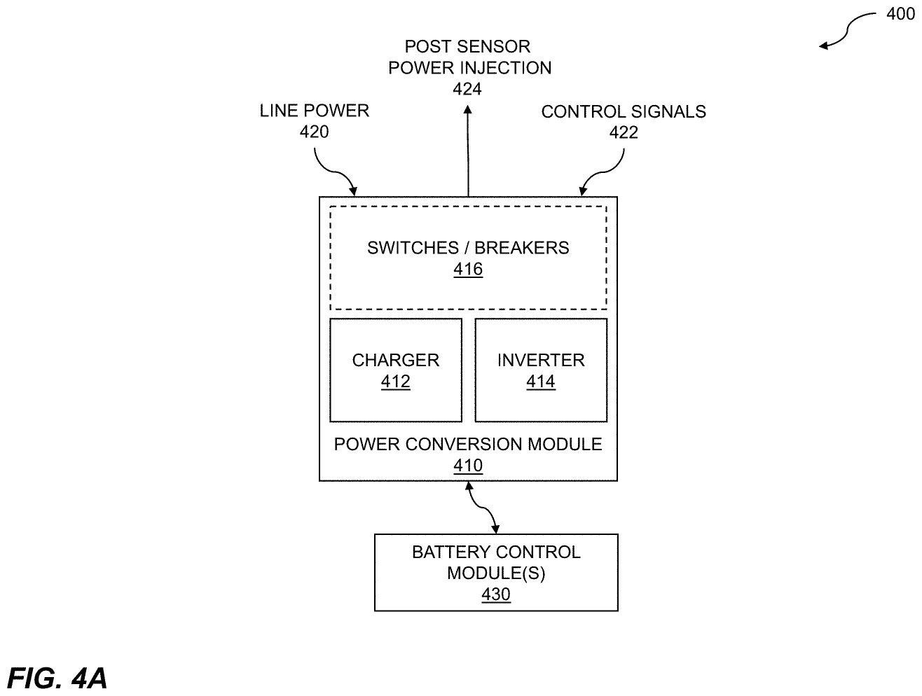

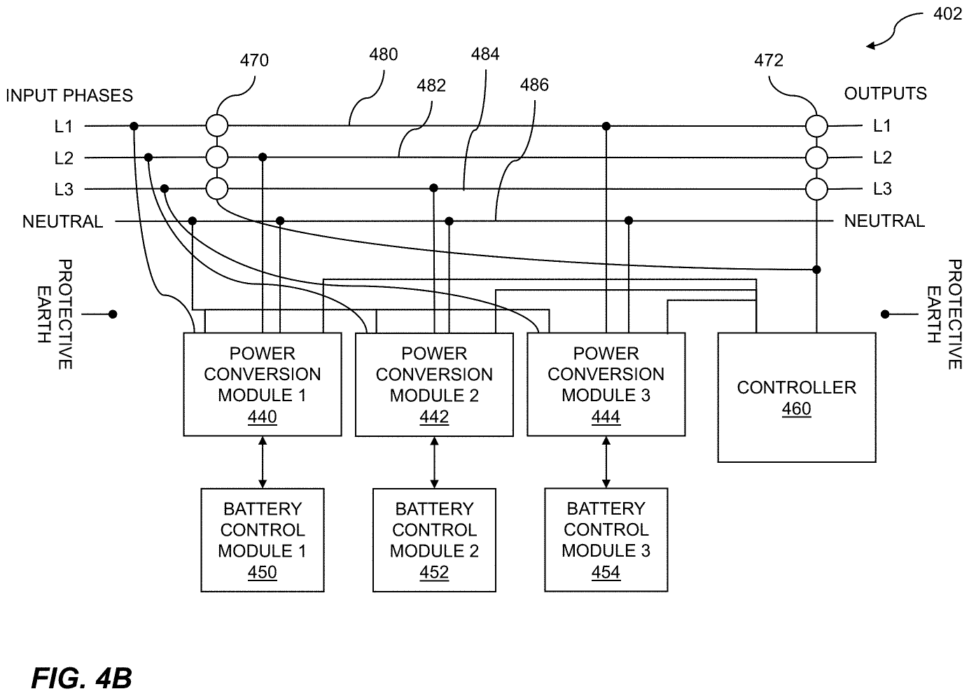

FIG. 4A is a block diagram of a power conversion module. A power conversion module 400 can be used to control storage of excess power. The power conversion module can further be used to inject power into a network such as the output of a UPS when a detected AC current requirement exceeds the amount of power available at a line input. The power conversion module enables datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

A power conversion module 410 is shown. A power conversion module can be a component within a power control block, where a power control block can include one or more power conversion modules, one or more battery control modules, and one or more power caches, which can comprise one or more batteries respectively controlled by the one or more battery control modules. In embodiments, a one-to-one relationship between battery control modules and power caches (batteries) is not maintained. The power conversion module can include a charger 412. The charger can convert AC power to DC power and can use the DC power to charge one or more storage components. The power conversion module can include an inverter 414. The inverter can be used to convert stored DC power to AC power. The DC voltage is greater than the peak AC voltage so that current always moves from the stored energy source to the AC power system when pulse width modulation is used to control the power transfer. In embodiments, the DC power can include a voltage substantially equal to, or greater than, the peak AC voltage being supplied by the inverter. The power conversion module can be coupled to switches or breakers 416, smart circuit breakers, and the like. The switches or breakers can be located within the power conversion module, located in a power panel coupled to the power conversion module, and the like. The power conversion module can receive line power 420. The line power can include single phase power such as 120 VAC. The power conversion module can be in communication with one or more control signals 422. The control signals can enable or disable switches or breakers, control the conversion of line power to DC power for charging storage components, and so on. The power conversion module can inject power 424 into a network such as the output network of a UPS. The power can be injected downstream of one or more current sensors or other sensors. The power conversion module can be coupled to one or more battery control modules 430. The battery control modules can be used to manage charging one or more batteries, capacitors, or other storage components, which can be integrated within the battery control module. The battery control modules can be used to monitor charge or discharge rate, storage component temperature, storage component health, and so on.

FIG. 4B is a block diagram for power conversion module usage 402. One or more power conversion modules can be used to convert or to store excess power, where the stored excess power can be used to meet an AC current requirement that can be in excess of available power. Power conversion module usage enables datacenter power management through phase balancing. Power for a datacenter is obtained across a plurality of power phases, and a power consumption value by loads within the datacenter is determined. A power consumption imbalance between phases is calculated, and phase power balancing is performed by transferring power from the first phase to the second phase. Power conversion modules, such as power conversion module 1 440, power conversion module 2 442, and power conversion module 3 444, can be coupled to one or more input power phases, such as input power phase L1 480, input power phase L2 482, and input power phase L3 484. In the example shown, input three-phase power is illustrated in a Wye configuration, so each power conversion module is also connected to power neutral 486. Power conversion module 1 440 receives input power from phase L1 and neutral and provides power to phase L2 and neutral. Power conversion module 2 442 receives input power from phase L2 and neutral and provides power to phase L3 and neutral. Power conversion module 3 444 receives input power from phase L3 and neutral and provides power to phase L1 and neutral. The one or more power conversion modules further can be coupled to protective earth. The one or more control modules can be coupled to one or more battery control modules such as battery control module 1 450 coupled to power conversion module 1, battery control module 2 452 coupled to power conversion module 2, battery control module 3 454 coupled to power conversion module 3, and so on. Battery control modules are also parallelable in order to create a range of energy storage capacity options for any given power capacity associated with a power conversion module. A power conversion module and a battery control module can comprise a power control block.

The one or more power conversion modules can be controlled by a controller 460. The controller can monitor current at the line inputs using one or more current sensors such as current sensor 470. The controller can control storage of available AC power from the line inputs within batteries or capacitors, conversion of AC power to DC power, and DC power control to AC power using injection of AC current into an output power system, and so on. The controller can monitor an amount of AC current in an output network using one or more current sensors, such as current sensor 472. Current sensors can be included within physical boundaries of the unit represented by block diagram 402, or they can be moved external to the physical boundaries to support primary and auxiliary unit functionality. In embodiments, the AC current that can be injected by the one or more power control blocks can be sourced by at least one of the one or more power caches. A power cache can include one or more batteries, one or more capacitors, and so on. The power control blocks can be managed or controlled by the datacenter power policy, where the datacenter power policy can be issued to individual hardware components within a datacenter topology. The block diagram 402 for the power control block can describe elements of an energy block for use in datacenter power management.

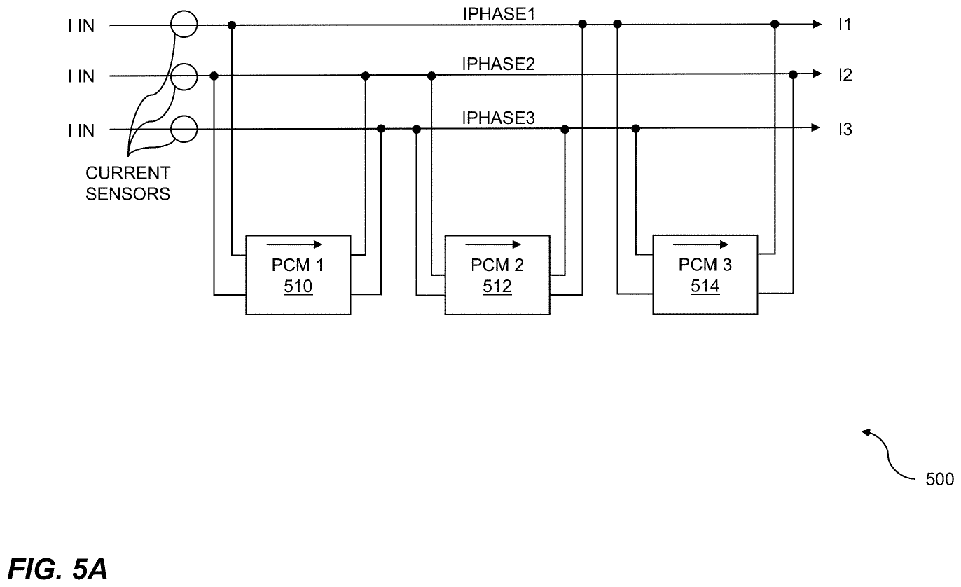

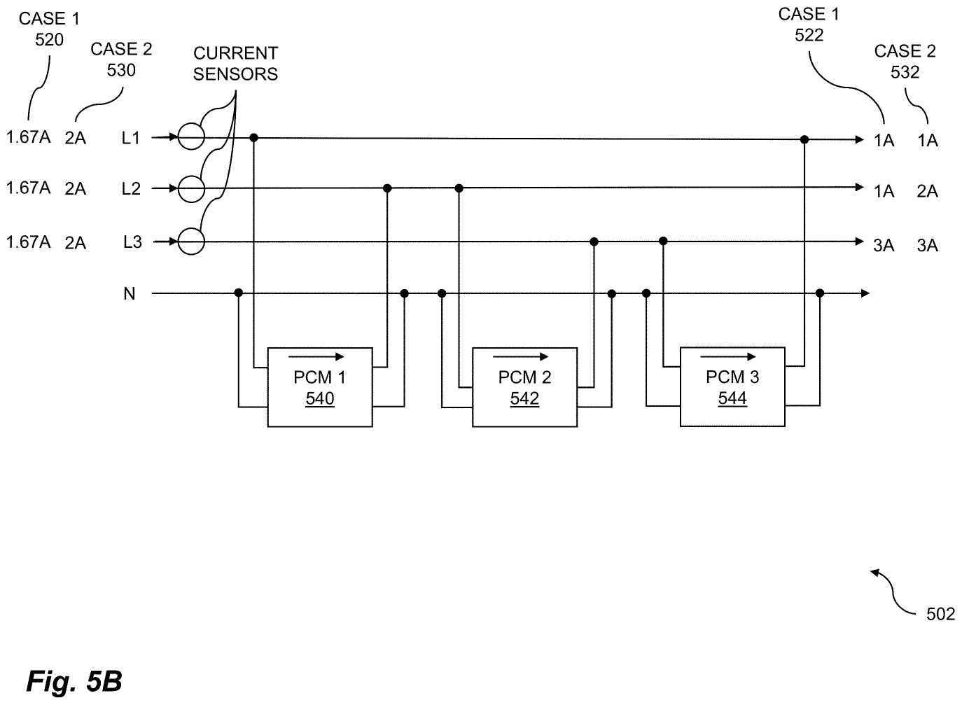

FIG. 5A shows daisy chained transfer for a Delta configuration. Discussed throughout, various techniques can be used for transferring power from one phase to another phase in order to accomplish phase power balancing. In embodiments, the transferring from a first phase to a second phase to a third phase of the plurality of power phases is accomplished using daisy chained transfer 500. The daisy chained transfer enables datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

Daisy chained transfer can enable power to be transferred from a first phase to a second phase. Similar transfers can be accomplished between further phases, such as the second phase to the third phase, from the third phase to the first phase, and so on. The daisy chained transfer from one phase is accomplished using one or more power conversion modules. In the example, three PCMs are shown, PCM 1 510, PCM 2 512, and PCM 3 514. Each PCM can provide power transfer from one phase to another phase.

FIG. 5B shows daisy chained transfer for a Wye configuration. A further daisy chained power transfer technique can include a Wye configuration 502. As for the Delta configuration discussed above, the Wye configuration can be used to accomplish power balancing by transferring power from one phase to another phase within a multiphase power system. The multiphase power system can include a three-phase power system. The daisy chained transfer in a Wye configuration enables datacenter power management through phase balancing. In embodiments, the power transfer can include transferring power from a first phase to a second phase to a third phase of the plurality of power phases. Power for a datacenter is obtained across a plurality of power phases. A power consumption value by loads within the datacenter is determined for each of the plurality of power phases. A power consumption imbalance is calculated between a first phase and a second phase from the plurality of power phases. Phase power balancing is performed by transferring power from the first phase to the second phase from the plurality of power phases within the datacenter. Further embodiments include transferring power from the second phase to a third phase of the plurality of power phases.

Noted previously, one or more daisy chained transfer techniques can be used to transfer power from one phase of multiphase power to a second phase of multiphase power to address power consumption imbalances between phases. Similarly, power transfers can be accomplished between first and third phases, second and third phases, and so on. A Wye configuration for daisy chained power transfer can include four leads comprising three power phase leads, such as phase leads L1, L2, and L3, and a neutral lead, N. The daisy chained power transfer from one phase to another phase is accomplished using one or more power conversion modules. In the example described here, three PCMs are shown, PCM 1 540, PCM 2 542, and PCM 3 544. Each PCM can provide transfer of power from one phase to another phase. PCM 1 can transfer power between L1 and L2; PCM 2 can transfer power between L2 and L3; and PCM 3 can transfer power between L3 and L1. Note that a voltage associated with a given phase is referenced to neutral, thus requiring connections from the power conversion modules to the neural lead N. Power consumption imbalances can be detected using current sensors, where one or more current sensors can be associated with each phase of multi-phase power. Based on data collected from the current sensors, the power conversion modules can be used to transfer power from an underutilized phase to an overutilized phase. The balanced power can be provided to loads associated with the calculated power consumption. The balanced power can include I Phase 1, I Phase 2, I Phase 3, and so on. When power balancing is not required, one or more of the power control modules can be turned off.

In a first usage example 520, case 1, input current on each phase equals 1.67 A. The desired output currents are shown 522. The desired output currents 1 A, 1 A, and 3 A correspond to phases one, two, and three, respectively. To achieve these output currents, 0.67 A current is transferred from phase one to phase two, and 1.33 A current is transferred from phase two to phase three. The transfers are accomplished with PCM 1 on, PCM 2 on, and PCM 3 off. In a second usage example 530, case 2, input current on each phase equals 2 A. The desired output currents are shown 532. The desired output currents 1 A, 2 A, and 3 A correspond to phases one, two, and three, respectively. To achieve these output currents, 1 A current is transferred from phase one to phase two, and 1 A current is transferred from phase two to phase three. The transfers are accomplished with PCM 1 on, PCM 2 on, and PCM 3 off. Note that PCM 3 can be used to transfer current from phase three to phase one.

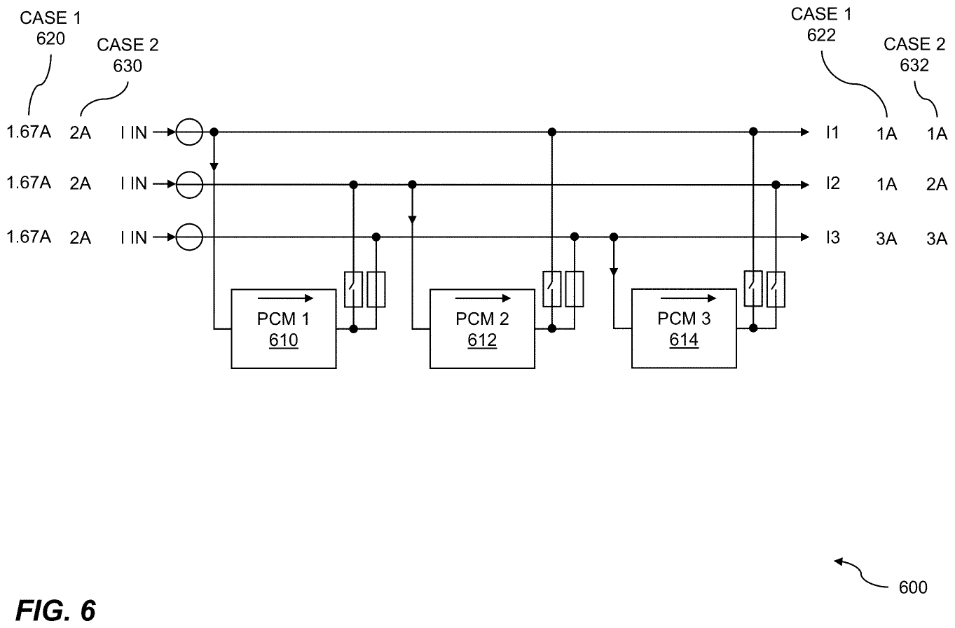

FIG. 6 illustrates unidirectional direct transfer. Direct transfer enables transfer of current from one phase to a second phase without having to first transfer current to an intermediate power phase. In embodiments, the transferring from the first phase to the second phase of the plurality of power phases is accomplished using unidirectional AC-to-AC direct transfer. The unidirectional AC-to-AC direct transfer enables datacenter power management through phase balancing 600. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

Unidirectional AC-to-AC direct transfer can enable power to be transferred from phase to phase. In embodiments, the transferring from the first phase to the second phase of the plurality of power phases can be accomplished using unidirectional AC-to-AC direct transfer. Similar transfers can be accomplished between further phases. Unidirectional AC-to-AC direct transfer can be accomplished between the second phase and the third phase, and the third phase and the first phase. The unidirectional transfer from one phase to a second phase is accomplished using one or more power conversion modules and switches. In the example, three PCMs are shown, PCM 1 610, PCM 2 612, and PCM 3 614. The output of each PCM is coupled via switches to phases different from the input phase to the PCM. For example, the input to PCM 1 is the first phase, and the switches at the output of PCM 1 are connected to the second phase and the third phase. Each PCM can provide unidirectional power transfer from one phase to another phase. In a first usage example 620, case 1, input current on each phase equals 1.67 A. The desired output currents are shown 622. The desired output currents 1 A, 1 A, and 3 A correspond to phases one, two, and three, respectively. To achieve these output currents, 0.67 A current is transferred from phase one to phase three, and 0.67 A current is transferred from phase two to phase three. The transfers are accomplished with PCM 1 on, PCM 2 one, and PCM 3 off. In a second usage example 630, case 2, input current on each phase equals 2 A. The desired output currents are shown 632. The desired output currents 1 A, 2 A, and 3 A correspond to phases one, two, and three, respectively. To achieve these output currents, 1 A current is transferred from phase one to phase to phase three. The transfers are accomplished with PCM 1 with the output of PCM 1 switched to phase three, PCM 2 off, and PCM 3 off.

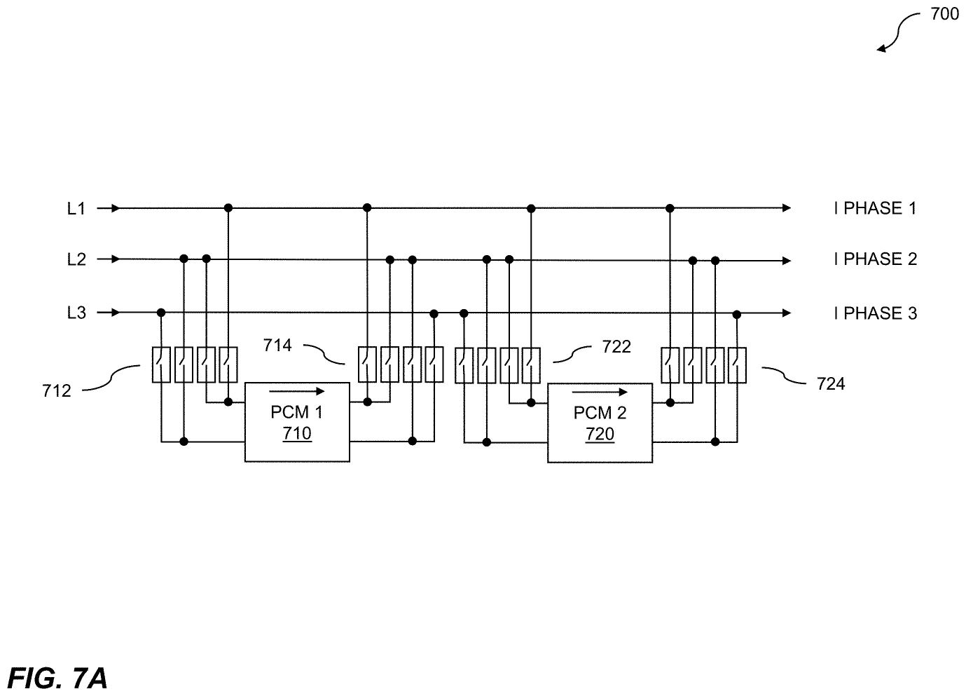

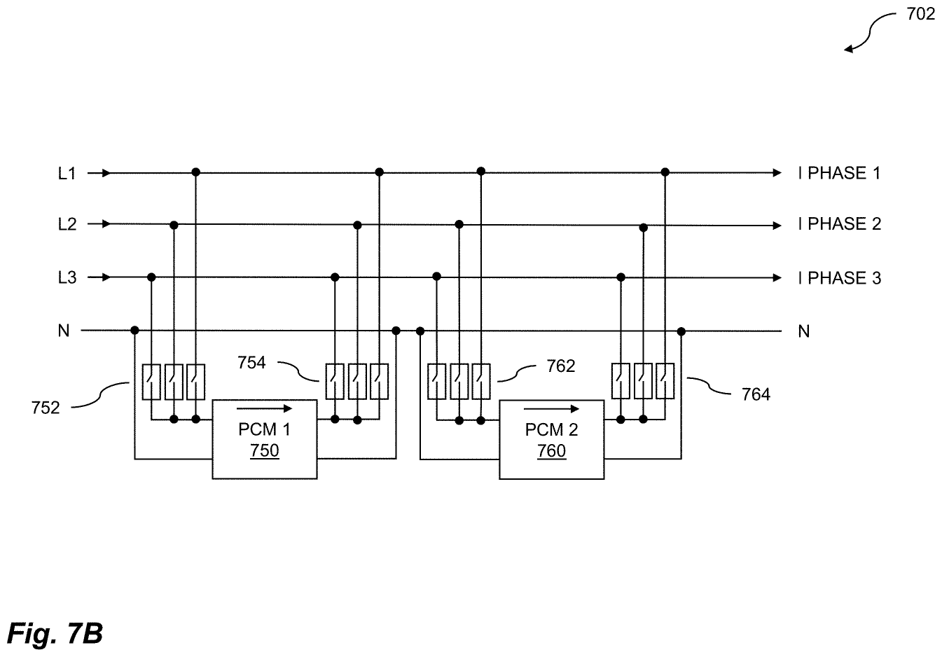

FIG. 7A shows direct transfer for a Delta configuration using N−1 PCMs with input and output switches. AC-to-AC direct transfer enables transfer of current from one power phase to a second power phase without having to transfer current to an intermediate power phase such as in the daisy chain example. By coupling a switch for each power phase to the input of a power conversion module (PCM), and a switch for each power phase to the output of the PCM, fewer PCMs can be used to perform phase power balancing. Unidirectional direct transfer using PCMs with input and output switches enables datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

Unidirectional AC-to-AC direct transfer using N−1 PCMs with input and output switches 700 enables power to be transferred among N power phases. In embodiments, the transferring from the first phase to the second or third phase of the plurality of power phases can be accomplished using unidirectional AC-to-AC direct transfer. Similar transfers can be accomplished between the second phase and the third phase, and the third phase and the first phase, etc. The unidirectional transfer from one phase to another phase is accomplished using one or more power conversion modules and switches. In the example, two PCMs are shown, PCM 1 710 and PCM 2 720. Input switches are used to selectively couple one of the power phases to the input of a PCM, and output switches are used to selectively couple the output of the PCM to one of the power phases. Input switches 712 can selectively couple one of the three power phases to the input of PCM 1 710, and output switches 714 can selectively couple the output of PCM 1 to one of the three power phases. Similarly, input switches 722 can selectively couple one of the three power phases to the input of PCM 2 720, and output switches 724 can selectively couple the output of PCM 2 to one of the three power phases. The number of PCMs has been reduced from three PCMs to two PCMs. This reduction is accomplished by adding switches to the inputs of the PCMs and the outputs of the PCMs. Since phase power is transferred only between two phases, then only the two PCMs are required for phase power switching among three power phases to address any possible imbalance among the phases. Thus, disclosed concepts include phase power balancing using N−1 power conversion modules to balance power across N AC power phases. As described above, the phase power balancing using N−1 power conversion modules is enabled by selectively controlled power conversion module switching among the N phases.

FIG. 7B shows direct transfer for a Wye configuration using N−1 PCMs with input and output switches. Power can be transferred from one power phase of multiphase power to another power phase. The power transfer can be enabled using one or more AC-to-AC direct current transfer techniques. In embodiments, the power transfer is enabled based on a Wye configuration, where the Wye configuration uses N−1 power conversion modules with associated input and output switches. AC-to-AC direct transfer from one power phase to a second power phase is accomplished directly between the phases without having to transfer current to an intermediate power phase. By coupling a switch associated each power phase to the input of a power conversion module (PCM), and coupling a switch for each power phase to the output of the PCM, the quantity of PCMs required to perform phase power balancing can be reduced. Unidirectional direct transfer using PCMs with input and output switches enables datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

Input and output switches 702 enable power to be transferred among N power phases. In addition to the N power phases, there can be a neutral (N) connection or feed. The power transfer, which is based on unidirectional AC-to-AC direct transfer uses N−1 power conversion modules (PCMs). In embodiments, the transferring of power from the first phase of the plurality of power phases to the second phase or third phase can be accomplished using unidirectional AC-to-AC direct transfer. Similar transfers can be accomplished between the second phase and the third phase, the third phase and the first phase, or other pairs of power phases. The transfers of power can be referenced to the neutral feed. Discussed above and throughout, the unidirectional transfer from one phase to another phase is accomplished using one or more power conversion modules and switches. In the example, two PCMs are shown, PCM 1 750 and PCM 2 760. Each PCM is further connected to the neutral feed. In embodiments, no switches are included between the neutral feed and the PCMs. Input switches are used to selectively couple one of the power phases referenced to neutral to the input of a PCM. Output switches are used to selectively couple the output of the PCM to one of the power phases. The outputs are also referenced to neutral. Input switches 752 can selectively couple one of the three power phases to the input of PCM 1 750, and output switches 754 can selectively couple the output of PCM 1 to one of the three power phases. Similarly, input switches 762 can selectively couple one of the three power phases to the input of PCM 2 760, and output switches 764 can selectively couple the output of PCM 2 to one of the three power phases. The number of power conversion modules has been reduced from three PCMs to two PCMs. This reduction is accomplished by adding switches to the inputs of the PCMs and the outputs of the PCMs. Since phase power is transferred only between two phases, then only two PCMs are required for phase power switch between the three power phases to address any possible imbalance between the phases. Thus, disclosed concepts include phase power balancing using N−1 power conversion modules to balance power across N AC power phases. As described above, the phase power balancing using N−1 power conversion modules is enabled by selectively controlled power conversion module switching among the N phases.

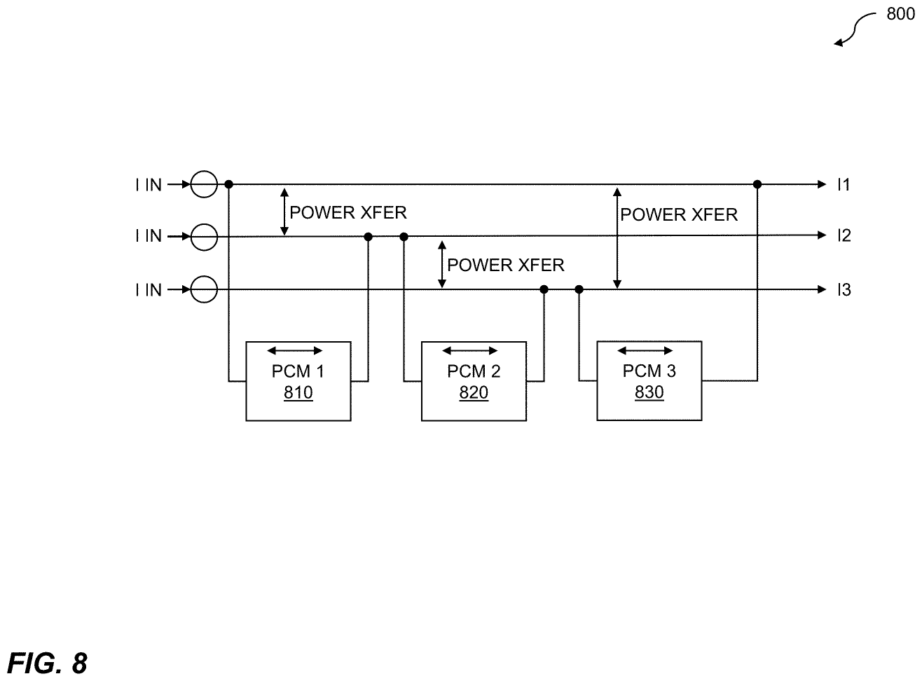

FIG. 8 illustrates bidirectional direct transfer. Bidirectional direct transfer enables transfer of current from one phase to a second phase without having to first transfer current to an intermediate power phase. In embodiments, the transferring from the first phase to the second phase of the plurality of power phases is accomplished using bidirectional AC-to-AC direct transfer. The bidirectional AC-to-AC direct transfer enables datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter. Bidirectional AC-to-AC direct transfer 800 uses PCMs to enable power to be transferred among power phases. Bidirectional direct transfer enables phase power transfer from a first phase to a second phase, and from the second phase to the first phase. Other bidirectional power phase transfers are enabled, such as between power phase 2 and power phase 3, and between power phase 3 and power phase 1. In the example, three PCMs are shown, PCM 1 810, PCM 2 820, and PCM 3 830. PCM 1 810 enables power transfer between a first phase and a second phase. PCM 2 820 enables power transfer between the second phase and a third phase. PCM 3 830 enables power transfer between the first phase and a third phase. By enabling the PCMs to be directional, switches at the inputs of the PCMs and switches at the outputs of the PCMs can be eliminated at the cost of adding an additional PCM.

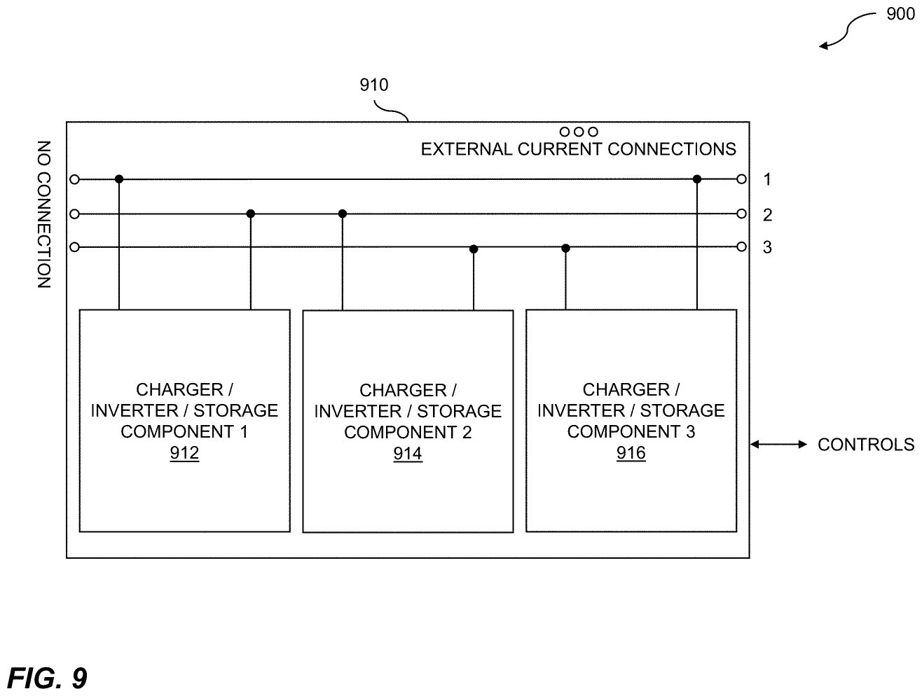

FIG. 9 shows phase power balancing using a PCM 900. Discussed throughout, phase power balancing can be accomplished using a power conversion module (PCM). The PCM enables datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

The PCM can be used to accomplish phase current balancing. A PCM can include components such as one or more chargers, one or more inverters, zero or more storage elements, and so on. A charger can be used to provide charge to one or more storage elements, where the storage elements can include batteries, capacitors, supplemental batteries, and so on. An inverter can used to convert DC charge from a storage element into AC power. In the example, the PCM 910 can include three charger/inverter/storage component sets such as component set 1 912, component set 2 914, and component set 3 916. In additional to charging and inverting, each charger/inverter/storage component set can perform phase power balancing by transferring power from a first phase to a second phase from the plurality of power phases. The PCM 910 can include controls and external current sense connections to the PCM.

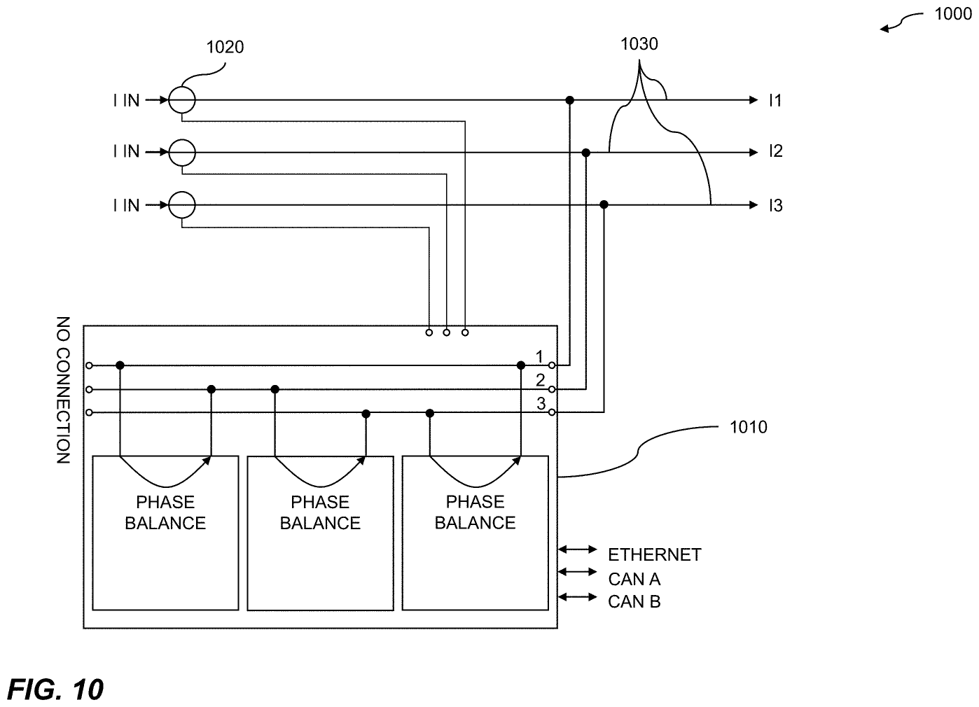

FIG. 10 illustrates PCM phase power balancing connections 1000. A power conversion module can be connected to a plurality of power phases for power phase balancing. Power phase balancing using the PCM enables datacenter power management. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

A power conversion module 1010 can include one or more charger/inverter/storage sets. The sets can include a charger convert AC power to DC charge, a storage element to store the DC charge, and an inverter to convert the DC charge to AC power. In the example, three such sets are shown. In addition to storing and inverting power, the PCM can perform phase power balancing. The phase power balancing is accomplished by transferring power from the first phase to the second phase from the plurality of power phases. In order to determine an amount of phase power, current, or voltage, sensors can be used. Current sensors 1020 associated with each of three input phases are shown. Each of the three phases is coupled 1030 to the PCM. The connections between the phases and the PCM are bidirectional, thus enabling the transferring of power from the first phase to the second phase of the plurality of power phases. The transferring of power is accomplished using bidirectional AC-to-AC direct transfer.

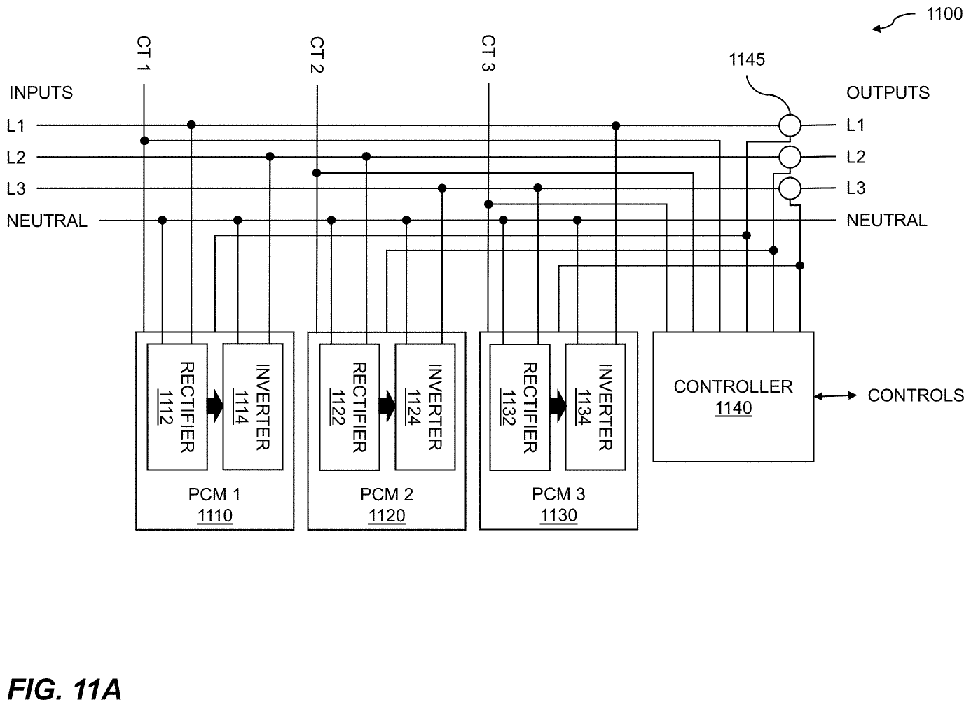

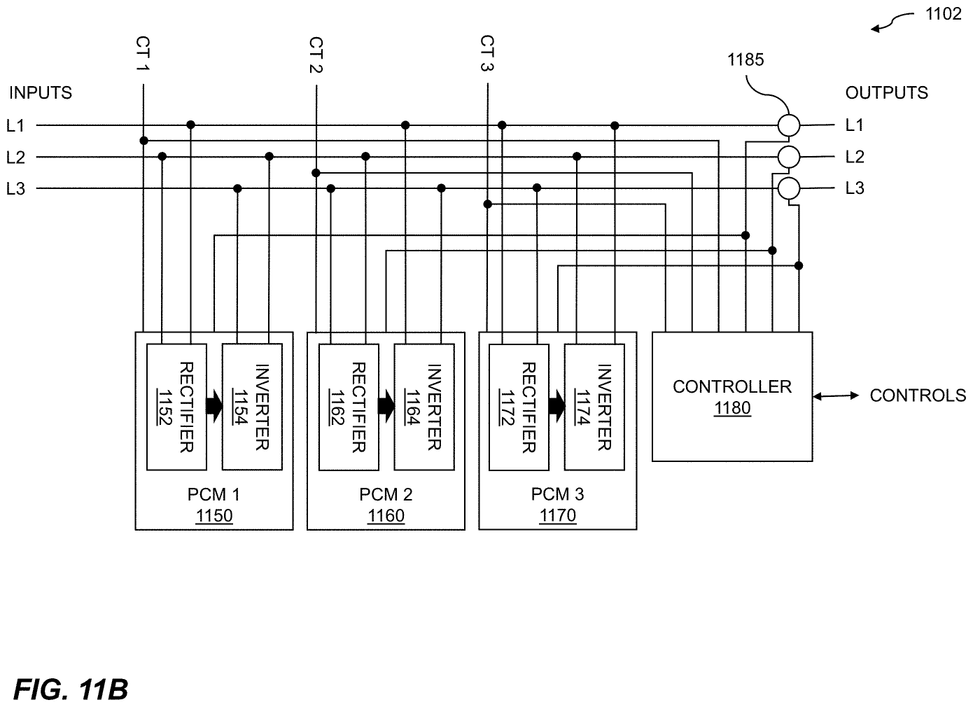

FIG. 11A illustrates a block diagram for phase balancing without storage in a Wye configuration. The phase balancing can be accomplished for a variety of multiphase power configurations including the Wye configuration discussed here, the Delta configuration described below, and so on. In embodiments, the multiphase power can include three-phase power. Discussed above and throughout, a power conversion module or PCM can be used to accomplish a variety of tasks associated with power such as multiphase power. The tasks can include rectifying (converting) AC energy to DC energy, storing energy, converting (inverting) stored energy, managing power flow for balancing power of multiple power phases, and so on. For the present example, energy storage is not required. Instead, the power from one phase can be rectified, inverted, and transferred to another phase without storing the rectified energy prior to inversion. In embodiments, the phase balancing is accomplished without energy storage. The power flow is managed by power or current balancing among phases of polyphase or multiphase power. Phase balancing without storage enables datacenter power management. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

In the example configuration 1100, three power conversion modules are shown, PCM 1 1110, PCM 2 1120, and PCM 3 1130. The number of PCMS can be substantially similar to the number of power phases, or different from the number of phases, such as an N−1 topology. Note that in a Wye configuration, a fourth lead, neutral or N is included. Each PCM can include various components such as rectifiers, inverters, and so on. In the present example, PCM 1 can include rectifier 1112 and inverter 1114; PCM 2 can include rectifier 1122 and inverter 1124; PCM 3 can include rectifier 1132 and inverter 1134; and so on. Current sensors, such as current sensors CT 1, CT 2, and CT 3 can be coupled to PCM 1, PCM 2, and PCM 3, respectively. Other current sensors coupled to PCMs can be included. The current sensors CT 1, CT 2, and CT 3 can be further coupled to a controller 1140. The controller can configure the one or more PCMs, operate the PCMs, and the like. One or more control, communication, or other signals can be coupled to the controller. The controller can determine power associated with power sources, and power associated with power loads. The power associated with power loads can be determined using current sensors 1145, where a current sensor can be associated with each phase of the plurality of power phases. The current sensors can be used to measure current on each phase across a plurality of power phases. Discussed above, a value for power consumption by loads for each phase of the plurality of power phases is determined, and a power consumption imbalance between power phases is calculated. The controller can configure and operate the PCMs to perform phase power balancing by transferring power as needed among phases using power connections. Note the power connections (phase connections) further include a connection to neutral. The transferring power can be used to increase power available on a phase that has insufficient power by transferring power from a phase that has a surplus of power. The transferring can be performed so as to avoid tripping a circuit breaker on one of the power phases, to avoid a limit due to wiring or transformer capacities on one of the power phases, etc. In embodiments, the phase power balancing is performed based on a power policy, a service level agreement (SLA), and so on.

FIG. 11B illustrates a block diagram for phase balancing without storage in a Delta configuration 1102. In addition to the Wye configuration described above, a Delta configuration, among other configurations, can accomplish phase balancing for a multiphase power configuration such as three-phase power. A PCM can be used to accomplish a variety of tasks such as rectifying (converting) energy, converting (inverting) energy, managing power flow, and so on, for balancing power of a plurality of power phases. For this example, as for the Wye example, energy storage is not required, since the power from one phase can be rectified, inverted, and transferred to another phase without storing the rectified energy. The power flow between phases is managed by power or current balancing between phases of multiphase power. Phase balancing without storage enables datacenter power management. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

Three power conversion modules are shown, PCM 1 1150, PCM 2 1160, and PCM 3 1170. The number of PCMS can be substantially similar to the number of power phases, or can be different from the number of phases. In embodiments, the phase power balancing can use N−1 power conversion modules to balance power across N AC power phases. Each PCM can include components, where the components can include rectifiers, inverters, etc. In this example, PCM 1 can include rectifier 1152 and inverter 1154; PCM 2 can include rectifier 1162 and inverter 1164; PCM 3 can include rectifier 1172 and inverter 1174; and so on. Current sensors can be coupled to PCM 1, PCM 2, and PCM, such as current sensors CT 1, CT 2, and CT 3 3, respectively. Additional sensors may be coupled to one or more of the PCMs. The current sensors CT 1, CT 2, and CT 3 can be further coupled to a controller 1180. The controller can be used to configure the one or more PCMs, operate the PCMs, etc., in order to enable power transfer among phases. One or more control, communication, network, or other connections and signals can be coupled to the controller. The controller can determine power associated with power sources, and power associated with power loads. The power associated with power loads can be determined using one or more current sensors 1185, where a current sensor can be associated with one or more phase of the plurality of power phases. The current sensors can be used to measure current on each phase across a plurality of power phases. A value is determined for power consumption by loads for each phase of the plurality of power phases, and a power consumption imbalance is calculated between power phases. The controller can address a power consumption imbalance by configuring and operating the PCMs to perform phase power balancing. The phase power balancing is accomplished by transferring power if needed between phases, using power connections. The transferring power can be used to increase power available on a phase that has insufficient power by transferring power from a phase that has a surplus of power. The transferring can be performed in order to avoid tripping a circuit breaker on one of the power phases, to avoid a current limit due to wiring or transformer capacities on one of the power phases, etc. In embodiments, the phase power balancing is performed based on a power policy, a service level agreement (SLA), and so on.

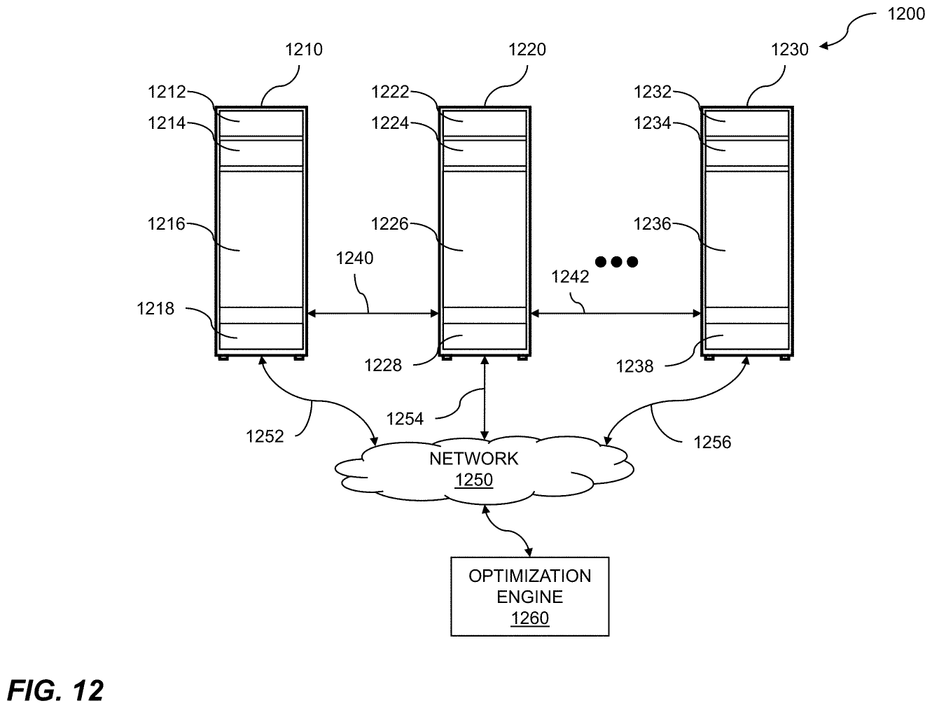

FIG. 12 illustrates a datacenter rack configuration. Data racks, also called information technology (IT) racks, contain a variety of electrical equipment components for which power is controlled. A datacenter can include multiple data racks to which managed power is provided. Power management includes datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter. The phase power balancing is accomplished using a power conversion module (PCM).

A datacenter can include multiple data or IT racks. Example 1200 includes three data racks, indicated as rack 1210, rack 1220, and rack 1230. While three data racks are shown in example 1200, in practice, there can be more or fewer data racks. The data rack 1210 includes a power cache 1212, a first server 1214, a second server 1216, and a power supply 1218. The power supply 1218 can be used for AC-DC conversion and/or filtering of power to be used by the servers 1214 and 1216, as well as replenishment of the power cache 1212. In embodiments, the power cache 1212 includes an array of rechargeable batteries. In embodiments, the batteries include, but are not limited to, lead-acid, nickel metal hydride, lithium ion, nickel cadmium, and/or lithium ion polymer batteries. Similarly, the data rack 1220 includes a power cache 1222, a first server 1224, a second server 1226, and a power supply 1228. Furthermore, the data rack 1230 includes a power cache 1232, a first server 1234, a second server 1236, and a power supply 1238. The data racks are interconnected by communication links 1240 and 1242. The communication links can be part of a local area network (LAN). In embodiments, the communication links include a wired Ethernet, Gigabit Ethernet, or another suitable communication link. The communication links enable each data rack to send and/or broadcast current power usage, operating conditions, and/or estimated power requirements to other data racks and/or upstream controllers such as a cluster controller. Thus, in the example 1200, a power cache can be located on each of the multiple data racks within the datacenter. In embodiments, the power cache includes multiple batteries spread across the multiple data racks.

Each rack may be connected to a communication network 1250. Rack 1210 is connected to network 1250 via communication link 1252. Rack 1220 is connected to network 1250 via communication link 1254. Rack 1230 is connected to network 1250 via communication link 1256. The optimization engine 1260 can retrieve operating parameters from each rack. In embodiments, the operating parameters are retrieved via SNMP (Simple Network Management Protocol), TR069, or other suitable protocol for reading information. Within a Management Information Base (MIB), various Object Identifiers (OIDs) may be defined for parameters such as instantaneous power consumption, average power consumption, number of cores in use, number of applications currently executing on a server, the mode of each application (suspended, running, etc.), internal temperature of each server and/or hard disk, and fan speed. Other parameters may also be represented within the MIB. Using the information from the MIB, the optimization engine 1260 may derive a new dispatch strategy in order to achieve a power management goal. Thus, embodiments include performing the optimizing with an optimization engine. Other power system deployments supported by energy blocks can include power shelves used in alternate open source rack standards, small footprint parallel connected blocks in dedicated racks housing switch gear, and even applications beyond data centers—wherever mission critical power systems have unused redundant capacity, and so on.

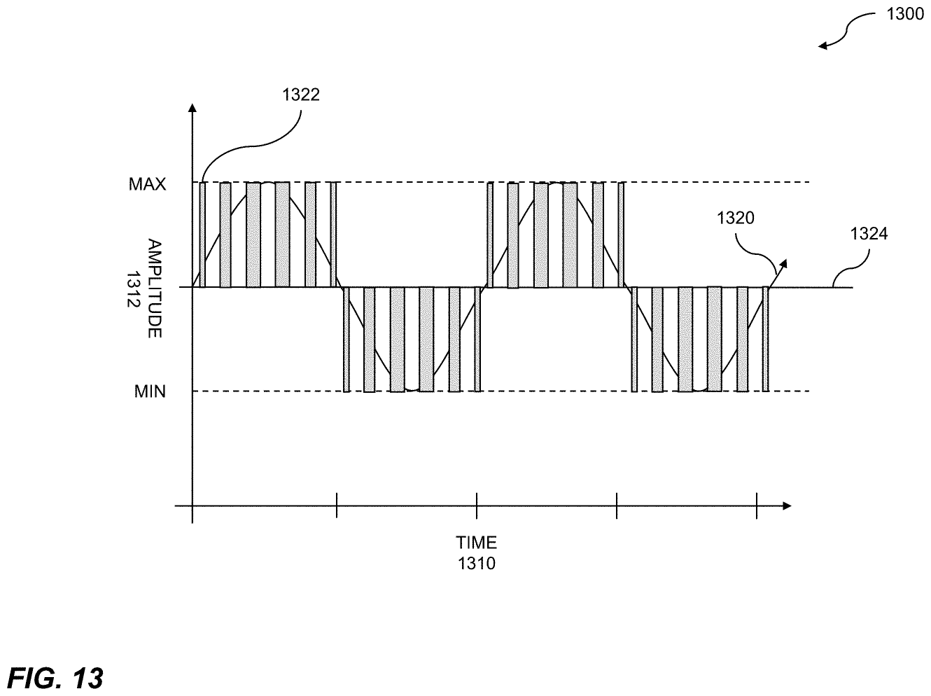

FIG. 13 illustrates pulse width modulation (PWM) of a sinusoid. Waveforms such as sinusoids, ramps, squares, etc., can be synthesized using various techniques. One or more techniques for generating a sinusoid or other waveform can be chosen based on various characteristics of the sinusoid such as frequency, noise tolerance, amplitude, tunability, synchronization with another sinusoid, and so on. By extension, a sinusoidal or AC voltage can be generated from a DC voltage using one or more techniques that can synthesize or reconstruct the AC voltage from the DC voltage. In embodiments, a sinusoid can be generated using pulse width modulation (PWM) 1300. Using PWM to synthesize an AC voltage from a DC voltage enables datacenter management using current injection. Power management includes datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter. The phase power balancing is accomplished using a power conversion module (PCM) using PWM.

Pulse width modulation of a sinusoid is shown. PWM can represent a sinusoid or other waveform with pulses of varying durations, frequencies, and duty cycles. The amplitudes of the pulses can be equal. The pulses can be realized by opening and closing a switch between an input and an output. As the sinusoid is represented by a sequence of pulses, the average power delivered to the load or output can be reduced. The amplitude 1312 of a sinusoid 1320 is plotted versus time 1310. A sequence of pulses, such as pulse 1322, can be generated. A narrow pulse such as pulse 1322 can represent a low current, a medium width pulse can represent an intermediate current, a wide pulse can represent a high current, and so on. Pulses with amplitudes greater than, or more positive with respect to the center line 1324, can represent a “positive” portion of the sinusoidal waveform, while pulses with amplitudes less than, or more negative with respect to the center line, can represent a “negative” portion of the sinusoidal waveform. The process can be performed in a constant RMS voltage circuit controlled by the source, and the stored energy voltage can be greater than the peak magnitude of the voltage waveform at the point of the current injection connection. The result is a current flow into the injection point. The PWM as illustrated in FIG. 13 is viewed at the output of the inverter. The connection point is a filtered sinusoidal current and the C-V characteristic of the connection point is not disturbed. A filter component can create a tuned impedance that prevents the source voltage from being affected as the current is injected. The result of the current injection is Power (P), which is defined by the product of the source voltage and the injected current. The load is not affected. The source power is reduced proportionately to the magnitude of the injected current.

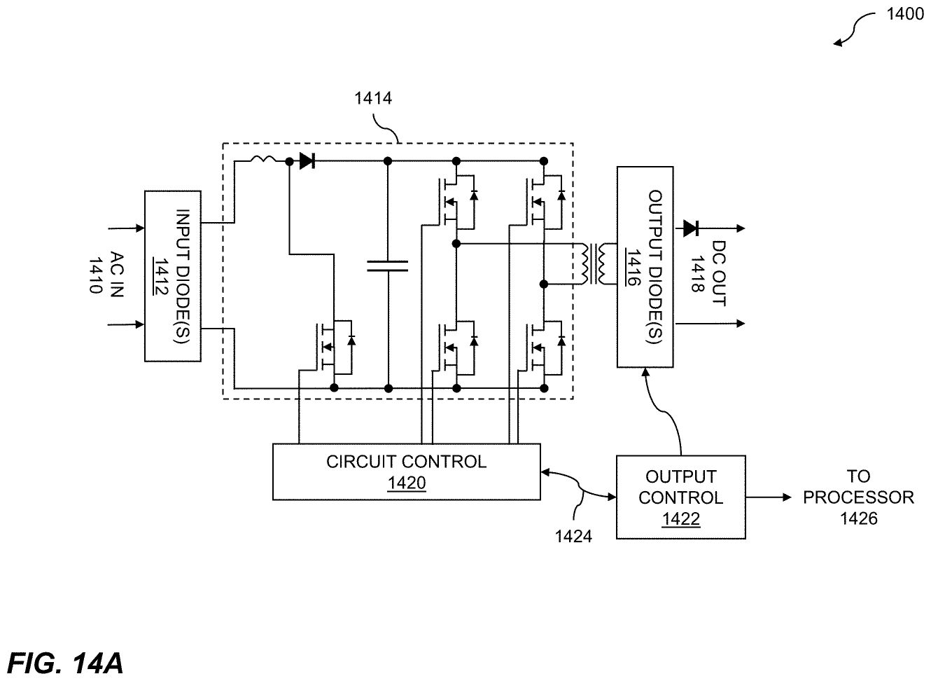

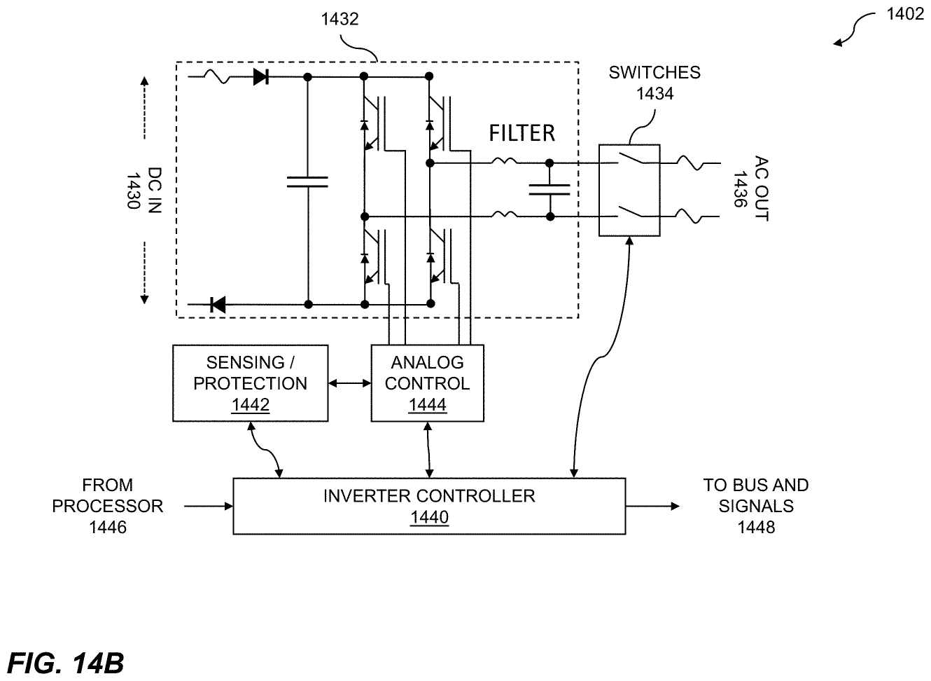

FIG. 14A is a block diagram for a charger. A power control block can store energy when excess energy is available, and source energy when energy is required to meet a detected AC current requirement. Excess energy can be available for use when the amount of energy available exceeds the amount of energy required to meet load demand at a given time (dI/dt). The excess energy harvesting technique enables capture of the excess energy for later use. The energy that is captured by energy harvesting can include excess AC current. In order the store the excess AC current, the excess AC power can be converted to DC power, where the DC power can be stored as energy in a DC storage cache. The DC energy can be stored in batteries, capacitors, and so on. The capturing and storing of the excess AC energy support datacenter power management using current injection. Power management includes datacenter power management through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter. The phase power balancing is accomplished using a power conversion module (PCM).

Energy can be stored in batteries, capacitors, and so on, by charging the batteries or capacitors. A block diagram for a charger is shown 1400. An AC input, such as a 120 VAC signal, can be provided at an input 1410 to the charger. The input signal can be rectified using input diodes 1412. The rectified signal can be applied to a charger circuit 1414. The charger circuit can be controlled by circuit control 1420. The circuit control can be used to monitor current, voltage, temperature, and so on for the charger circuit; to monitor current or voltage being provided to storage batteries or capacitors; to monitor charge state or temperature of the batteries or capacitors; and the like. The voltage or current generated by the charger circuit can be coupled to output diodes 1416 through a transformer. The output from the output diodes, DC output 1418, can be used to charge storage batteries, storage capacitors, etc. The output of the charger can be controlled by output control 1422. The output control, which can be coupled 1424 to the circuit control, can be used to control charging of one or more types of batteries, capacitors, etc. In a usage example, the output control can provide constant current during initial charging, then can provide constant voltage after a charge level threshold has been attained. The output control can be used to monitor the battery, thereby preventing damage to or catastrophic failure of the battery. Such battery management can also provide a safer use environment for the battery and/or an extended battery lifetime, among other benefits. The circuit control and the output control can be coupled to a processor 1426. The processor can include a PC, a microprocessor, a microcontroller, and so on.

FIG. 14B is a block diagram for a single-phase inverter. Power can be injected by one or more power control blocks into a network such as the output network of a UPS. Discussed throughout, the power control blocks, the power caches, or the battery control modules can store energy collected when power capacity is greater than load demand and can provide energy based on a detected AC current requirement. One or more single-phase inverters can support datacenter power management using current injection. A single-phase inverter block diagram is shown 1402, where the single-phase inverter can be used to generate an AC output based on stored energy. The stored energy, which can be stored in batteries, capacitors, and so on, can be used to provide a DC input 1430 to an inverter circuit 1432. The inverter circuit can be coupled to switches 1434, breakers, smart breakers, and so on, where the switches can be used to couple the output of the inverter to an AC output 1436. The AC output voltage 1436 is set by the constant voltage, constant frequency output of the UPS system, or another power source. The DC input voltage is greater than the peak magnitude of AC source voltage. The inverter control techniques and the output filter convert the inverter output to an AC current in phase with and with the same frequency as the source voltage, using pulse width modulation techniques. The resulting current injection transfers power to the power system at the connection point without disturbing the constant voltage, constant frequency characteristics. The inverter can be controlled by an inverter controller 1440. The inverter controller can perform sensing and protection 1442 such as over or under voltage of the DC input, presence of a DC input voltage, over current of the AC output, and the like. The inverter controller can operate analog control 1444 of the inverter. The inverter controller can communicate with a processor 1446.

The processor, which can include a PC, a microprocessor, etc., can be used to apply a datacenter power policy. The inverter can be coupled to a bus or to signals 1448, where the bus can include a bus within a data rack, between data racks, etc. The signals can include control signals, operating values, and the like. In embodiments, three single-phase inverters such as 1402 can be applied to injection of AC current into three-phase AC power. A filter is shown before switches 1434 and output 1436, which includes series inductors and a capacitor between the output lines. This filter can be used in conjunction with the PWM applied to the DC voltage, as described in the FIG. 4 section. The output impedance of circuit 1432 allows a source voltage to exist on the output side of the circuit while current is flowing through the output. This output point is held at a constant voltage by the source, and the injected current is in phase with the voltage. This results in less current being required by the source to supply the load, and hence less power demand. The single-phase inverter block shown in diagram 1402 can comprise a grid tie inverter.

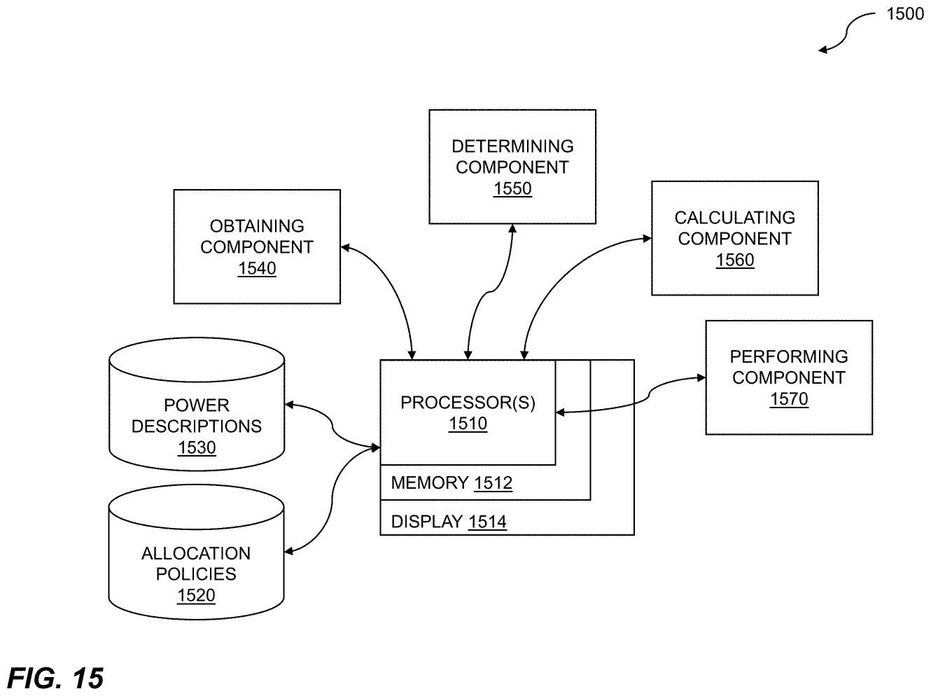

FIG. 15 is a system diagram for datacenter power management through phase balancing. Power phase imbalances can result from power loads drawing power from a plurality of power phases. The imbalances can result from uneven allocation of power loads to power phases, an increased number of power loads such as turning on a power phase, and so on. Power can be transferred from one phase to another phase to balance the phases. Datacenter power management is enabled through phase balancing. Power for a datacenter is obtained across a plurality of power phases. A power consumption value by loads within the datacenter is determined for each of the plurality of power phases. A power consumption imbalance is calculated between a first phase and a second phase from the plurality of power phases within the datacenter. Phase power balancing is performed by transferring power from the first phase to the second phase from the plurality of power phases within the datacenter.

The system 1500 can include one or more processors 1510 and a memory 1512 which stores instructions. The memory 1512 is coupled to the one or more processors 1510, wherein the one or more processors 1510 can execute instructions stored in the memory 1512. The memory 1512 can be used for storing instructions; for storing databases of components such as power sources, power caches, and power loads; for phase loading information; for storing information pertaining to load requirements or redundancy requirements; for storing power policies; for storing service level agreements; for system support; and the like. Information regarding datacenter power management through phase balancing can be shown on a display 1514 connected to the one or more processors 1510. The display can comprise a television monitor, a projector, a computer monitor (including a laptop screen, a tablet screen, a netbook screen, and the like), a smartphone display, a mobile device, or another electronic display.

The system 1500 includes allocation policies 1520. The allocation polices can include power policies, dynamic power policies, service level agreements, and so on. In embodiments, the allocation policies 1520 are stored in a networked database, such as a structured query language (SQL) database. The allocation policies 1520 can include limits, such as power consumption limits, as well as switch configurations when certain conditions are met. For example, when conditions allow peak shaving to take place, and surplus power exists, the power policies can identify switches and their configurations, which allow replenishing of one or more power caches. The system 1500 further includes a repository of power descriptions 1530. The power descriptions 1530 can include, but are not limited to, power descriptions of power loads, power caches, power supplies, rack power profiles, batteries, buses, circuit breakers, fuses, and the like. The power descriptions can include physical space needs, electrical equipment cooling requirements, etc. The system 1500 can include an obtaining component 1540. The obtaining component 1540 can be used for obtaining power for a datacenter across a plurality of power phases. The number of power phases can include three power phases, although two or more power phases can be included. The power phases can be obtained from grid power; locally generated power such as power from wind, solar, micro-hydro; etc.

The system 1500 includes a determining component 1550. The determining component 1550 is configured to determine a power consumption value by loads within the datacenter for each of the plurality of power phases. The loads in a datacenter can include processing and storage equipment, communications gear, HVAC, and so on. The power consumption per load can be based on whether a processor is in lower power mode, idling, normal operation, accelerated operation such as an increased clocking rate, etc. Some loads can be coupled to a single power phase, while other loads can be coupled to more than one phase. The system 1500 includes a calculating component 1560. The calculating component 1560 can calculate a power consumption imbalance between a first phase and a second phase from the plurality of power phases within the datacenter. The power consumption balance can be based on numbers and types of equipment coupled to a phase, the level of operation of a given piece of equipment, and so on. Embodiments include determining a physical location for the power consumption imbalance. The physical location, which can include a datacenter rack, a datacenter row, a portion of the datacenter, and so on, can include more items of electrical or processing equipment, a higher density of equipment, a higher level of processing activity, etc.

The system 1500 includes a performing component 1570. The performing component 1570 can perform phase power balancing by transferring power from the first phase to the second phase from the plurality of power phases within the datacenter. Power can be transferred from the first phase to the second phase using a variety of techniques. In embodiments, the performing phase power balancing by transferring power from the first phase to the second phase can be accomplished by supply side transfer of power. That is, power can be transferred from the feed end of a phase rather than the load end of the feed. Power can be transferred between additional phases such as a third phase. The transferring from the first phase to the second phase to the third phase can be accomplished using daisy chained transfer. Switches such as smart switches can be used for the transferring. In embodiments, the transferring can be accomplished using unidirectional or bidirectional AC-to-AC direct transfer; using switches, etc. The power that is transferred can be converted from DC power, where the DC power can be obtained from a battery, a UPS, and the like. In embodiments, the phase power balancing is accomplished using a power conversion module (PCM). The transferring power can be accomplished manually. In embodiments the performing phase power balancing by transferring power from the first phase to the second phase is accomplished automatically. Recall that the power imbalance between phases can include determining a physical location for the power consumption imbalance. In embodiments, the transferring power from the first phase to the second phase can be accomplished in proximity to the physical location for the power consumption imbalance. The transferring power from one phase to another phase can be based on a script, a policy, and so on. In embodiments, the phase power balancing is accomplished while maintaining a service level agreement redundancy level. The level of redundancy that can be maintained based on a service level agreement (SLA) can include N redundancy, N+1 redundancy, 2N redundancy, and the like. The power balancing can be based on a threshold value, where the threshold value can include an amount of power available, a number of power loads, a number of devices coupled to a phase, etc. The phase power balancing between phases can be accomplished for other purposes such as safety purposes. In embodiments, the phase power balancing is performed to avoid tripping a circuit breaker on one of the phases from the plurality of power phases. In other embodiments, the phase power balancing is performed to avoid a limit due to wiring or transformer capacities on one of the phases from the plurality of power phases.

The system 1500 includes a computer system for power management comprising: a memory which stores instructions; one or more processors attached to the memory wherein the one or more processors, when executing the instructions which are stored, are configured to: obtain power for a datacenter across a plurality of AC power phases; determine a power consumption value by loads within the datacenter for each of the plurality of power phases; calculate a power consumption imbalance between a first phase and a second phase from the plurality of power phases within the datacenter; and perform phase power balancing by transferring power from the first phase to the second phase from the plurality of power phases within the datacenter, wherein the transferring power is accomplished using current injection.

Disclosed embodiments include a computer program product embodied in a non-transitory computer readable medium for power management, the computer program product comprising code which causes one or more processors to perform operations of: obtaining power for a datacenter across a plurality of AC power phases; determining a power consumption value by loads within the datacenter for each of the plurality of power phases; calculating a power consumption imbalance between a first phase and a second phase from the plurality of power phases within the datacenter; and performing phase power balancing by transferring power from the first phase to the second phase from the plurality of power phases within the datacenter, wherein the transferring power is accomplished using current injection.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited neither to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for power management comprising:
obtaining power for a datacenter across a plurality of AC power phases;
determining a power consumption value by loads within the datacenter for each of the plurality of power phases;
calculating a power consumption imbalance between a first phase and a second phase from the plurality of power phases within the datacenter; and
performing phase power balancing by transferring power from the first phase to the second phase from the plurality of power phases within the datacenter, wherein the transferring power is accomplished using current injection.

2. The method of claim 1 wherein the performing phase power balancing by transferring power from the first phase to the second phase comprises a supply side transfer of power.

3. The method of claim 2 wherein performing phase power balancing by transferring power from the first phase to the second phase is accomplished without transferring load power consumption between power phases.

4. The method of claim 1 wherein the plurality of power phases comprises three phases.

5. The method of claim 4 further comprising transferring power from the second phase to a third phase of the plurality of power phases.

6. The method of claim 5 wherein the transferring from the first phase to the second phase to the third phase of the plurality of power phases is accomplished using daisy chained transfer.

7. The method of claim 4 wherein the transferring from the first phase to the second phase of the plurality of power phases is accomplished using unidirectional AC-to-AC direct transfer.

8. The method of claim 7 wherein the transferring is accomplished using switching elements.

9. The method of claim 4 wherein the transferring from the first phase to the second phase of the plurality of power phases is accomplished using bidirectional AC-to-AC direct transfer.

10. The method of claim 1 wherein the phase power balancing is accomplished using a power conversion module (PCM).

11. The method of claim 10 wherein the phase power balancing is accomplished without a battery being included in the power conversion module.

12. The method of claim 10 wherein the power conversion module enables a charger and an inverter simultaneously.

13. The method of claim 10 wherein the power conversion module is coupled to a supplemental battery pack.

14. The method of claim 1 wherein the performing phase power balancing by transferring power from the first phase to the second phase is accomplished automatically.

15. The method of claim 1 further comprising determining a physical location for the power consumption imbalance.

16. The method of claim 15 wherein the transferring power from the first phase to the second phase is accomplished in proximity to the physical location for the power consumption imbalance.

17. The method of claim 1 wherein the phase power balancing is accomplished while maintaining a service level agreement redundancy level.

18-20. (canceled)

21. The method of claim 1 wherein the phase power balancing is performed based upon a threshold value of power imbalance.

22-23. (canceled)

24. The method of claim 21 wherein the phase power balancing is performed based on a power policy.

25-28. (canceled)

29. The method of claim 1 wherein the phase power balancing uses N−1 power conversion modules to balance power across N AC power phases.

30. The method of claim 29 wherein the phase power balancing using N−1 power conversion modules is enabled by selectively controlled power conversion module switching among the N phases.

31. A computer program product embodied in a non-transitory computer readable medium for power management, the computer program product comprising code which causes one or more processors to perform operations of:
obtaining power for a datacenter across a plurality of AC power phases;
determining a power consumption value by loads within the datacenter for each of the plurality of power phases;
calculating a power consumption imbalance between a first phase and a second phase from the plurality of power phases within the datacenter; and
performing phase power balancing by transferring power from the first phase to the second phase from the plurality of power phases within the datacenter, wherein the transferring power is accomplished using current injection.

32. A computer system for power management comprising:
a memory which stores instructions;
one or more processors attached to the memory wherein the one or more processors, when executing the instructions which are stored, are configured to:
obtain power for a datacenter across a plurality of AC power phases;
determine a power consumption value by loads within the datacenter for each of the plurality of power phases;
calculate a power consumption imbalance between a first phase and a second phase from the plurality of power phases within the datacenter; and
perform phase power balancing by transferring power from the first phase to the second phase from the plurality of power phases within the datacenter, wherein the transferring power is accomplished using current injection.
